(19) United States
(12) Patent Application Publication
(10) Pub. No.: US 2023/0104685 A1
(43) Pub. Date: Apr. 6, 2023

(54) POWER MANAGEMENT CIRCUITRY

(71) Applicant: Intel Corporation, Santa Clara, CA (US)

(72) Inventors: PATRICK KAM-SHING LEUNG, PORTLAND, OR (US); STEPHEN H. GUNTHER, BEAVERTON, OR (US); TREVOR LOVE, WILSONVILLE, OR (US); VASUDEV BIBIKAR, AUSTIN, TX (US); PHILIP R. LEHWALDER, HILLSBORO, OR (US); PREETI AGARWAL, PORTLAND, OR (US)

(21) Appl. No.: 17/802,362

(22) PCT Filed: Jul. 15, 2020
(86) PCT No.: PCT/US2020/042126

§ 371 Date: Aug. 25, 2022

Related U.S. Application Data
(63) Continuation-in-part of application No. 16/832,012, filed on Mar. 27, 2020, now Pat. No. 11,314,299.

(51) Int. Cl. G06F 1/3296; G06F 1/3287; G06F 1/3234; G06F 1/3206

(52) U.S. Cl. CPC G06F 1/3296; G06F 1/3287; G06F 1/3243; G06F 1/3206

(57) ABSTRACT

Power management circuitry may be provided to control a power state of a voltage regulator for providing a regulated voltage to a load, the voltage regulator being operable in at least first and second different power states. The power management circuitry may comprise circuitry to determine output current data relating to an output current to be provided by the voltage regulator to the load. The power management circuitry may comprise circuitry to determine regulated voltage data relating to a regulated voltage to be provided by the voltage regulator to the load. The power management circuitry may comprise circuitry to cause a change in the power state of the voltage regulator from the first power state to the second power state based on a comparison of the determined output current data and power state current threshold data.

### RELATED APPLICATION

This application claims priority to U.S. application Ser. No. 16/832,012, entitled “SYSTEM, APPARATUS AND METHOD FOR DYNAMIC POWER STATE SCALING OF A VOLTAGE REGULATOR FOR A PROCESSOR,” filed Mar. 27, 2020.

### TECHNICAL FIELD

This disclosure relates to power management of a voltage regulator for providing a regulated voltage to a load.

### BACKGROUND

Current industry trends are towards the provision of smaller, lighter and thinner computer systems. In particular, mobile devices, including laptop computers, tablet computers, etc. continue to be reduced in size. Batteries may represent a significant proportion of the bulk of a device in order to provide sufficient useful operating time. Reducing the power consumption of the computer system may allow increased operating time or for the battery size to be reduced. Reducing power consumption of devices operating on mains power is also important for energy compliance.

### BRIEF DESCRIPTION OF THE DRAWINGS

Embodiments described herein are illustrated by way of example, and not by way of limitation, in the figures of the accompanying drawings in which like reference numerals refer to similar elements:

FIG. 1a schematically illustrates a voltage regulator providing an output current and a regulated voltage to a load;

FIGS. 1b and 1c schematically illustrate the voltage regulator providing an output current and a regulated voltage to the load with the load and the voltage regulator comprising the power management circuitry respectively;

FIG. 2 is a table showing three example power states of a voltage regulator;

FIG. 3 shows plots of power efficiencies of three power states of a voltage regulator as functions of the output current to be provided by the voltage regulator to a load;

FIG. 4 shows an upper illustrative plot of power efficiency versus output current for three different power states of a voltage regulator providing a first (higher) regulated voltage to a load and a lower illustrative plot of power efficiency versus output current for the three different power states of the voltage regulator providing a second (lower) regulated voltage to the load;

FIG. 5 shows empirically obtained plots of power efficiency versus output current for two different power states of a voltage regulator for each of a plurality of different regulated voltages provided by the voltage regulator to a load;

FIG. 6 is a plot of a power state current threshold of the voltage regulator as a function of the regulated voltage to be provided by the voltage regulator to the load, the plot of FIG. 6 being derived from the plots of FIG. 5;

FIG. 7 illustrates the error in the power state current threshold of the plot of FIG. 6 estimated by way of a best fit straight line function;

FIG. 8 shows the plot of FIG. 3 and a dotted line illustrating the power efficiencies which can be achieved by accurately switching between the power states of the voltage regulator;

FIG. 9 is a block diagram of power management circuitry;

FIG. 10 schematically illustrates three voltage regulators providing respective output currents and regulated voltages to respective loads of a system on chip;

FIG. 11 is a block diagram of a computing device;

FIG. 12 is a flow chart of a method of controlling a power state of a voltage regulator for providing a regulated voltage to a load;

FIG. 13 is a flow chart of a method of determining a dependency of a power state current threshold of a voltage regulator on a regulated voltage to be provided by the voltage regulator to a load;

FIG. 14 is a flow chart of a method of controlling a power state of a voltage regulator for providing a regulated voltage to a load; and

FIG. 15 is a block diagram of a machine-readable medium.

### DESCRIPTION

Illustrative examples of the present disclosure include, but are not limited to, power management circuitry, methods, apparatus, means and machine readable instructions for controlling a power state of a voltage regulator or for determining a dependency of a power state current threshold of a voltage regulator on a regulated voltage to be provided by the voltage regulator to a load. A computer platform is also disclosed.

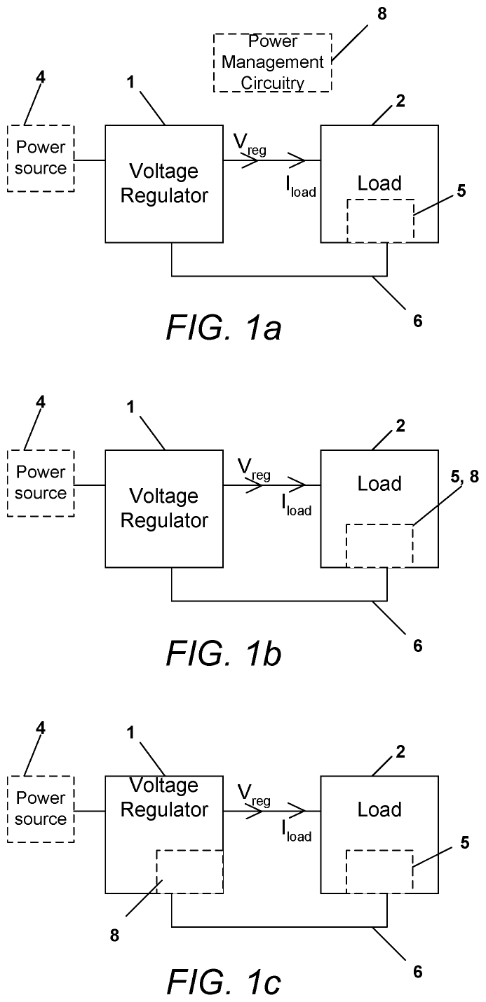

FIG. 1a schematically illustrates a voltage regulator 1 to provide a regulated voltage, V_{reg}, and an output current, I_{load}, to a load 2. The voltage regulator 1 may be powered by an electrical power source 4 which may be a direct current (DC) power source such as a battery or an alternating current (AC) power source such as mains power. The regulated voltage, V_{reg}, provided by the voltage regulator 1 to the load 2 may be, for example, a regulated DC voltage. The voltage regulator 1 may be to provide a variable regulated voltage, V_{reg}, to the load 2. For example, it may be that the load is operable at a plurality of different voltage operating points, such as a plurality of different discrete voltage operating points. The voltage regulator 1 may be configured to receive a load voltage demand signal indicating a voltage demanded from the voltage regulator 1 for the load 2 and to supply the regulated voltage, V_{reg}, to the load 2 in accordance with (e.g. to meet) the voltage demanded from the voltage regulator 1 for the load 2. For example, a load power controller 5 (such as a load power control unit) may be provided by circuitry of or integrated with the load 2 (e.g. the load power controller 5 may be provided on the same chip, in the same package or on the same integrated circuit die as the load 2). The load power controller 5 may be to determine a desired voltage operating point of the load 2. The load power controller 5 may be to send a load voltage demand signal indicating a demanded regulated voltage V_{reg} from the voltage regulator 1 for the load 2 depending on the determined desired voltage operating point of the load 2. The voltage regulator 1 may be configured to adjust the regulated voltage, V_{reg}, it supplies to the load 2 in response to or depending on a load voltage demand signal indicating an adjusted voltage demanded from the voltage regulator 1 for the load 2 (e.g. when the load 2 is to operate at a different voltage operating point). The load voltage demand signal may communicate the voltage demanded from the voltage regulator 1 for the load 2 by way of a voltage identification, VID, code which may be a binary code indicative of a voltage demanded from the voltage regulator 1 for the load 2. The load voltage demand signal may be sent to the voltage regulator 1 by way of a power management communication interface 6 such as a power management bus.

The load 2 may be any suitable load. For example, the load 2 may be a load of a computer platform. The load 2 may be provided on an integrated circuit die, for example the load may comprise one or more integrated circuits of an integrated circuit die. It may be that the load 2 comprises any one or more of: a computing platform; one or more components of a computing platform (e.g. one or more processors, one or more processor chips, multicore processing circuitry, at least one domain of a multi-core processing circuitry, such as a domain comprising one or more processing cores, or a fan or a display or a memory controller of a computer platform); one or more processors; one or more processor chips; circuitry of a processor or processor chip; processing or computing circuitry of a processor or processor chip; one or more domains of a processor chip, such as a domain comprising one or more cores of a multi-core processor; processing circuitry of a central processing unit of a processor chip, such as one or more central processing unit cores; graphics processing circuitry of a processor chip, such as one or more graphics processor cores; at least a first domain of multi-core processing circuitry further comprising a second domain including at least graphics processing circuitry, the first domain including one or more processing cores, such as one or more processing cores of a central processing unit processor; a memory controller; a display controller; non-core circuitry of a processor or processor chip.

It may be that the processor chip, where provided, comprises a dedicated central processing unit chip (such as a dedicated central processing unit chip for a personal computer, such as a desktop personal computer) or a system on chip, SoC, comprising one or more processors, such as one or more central processing unit processors and one or more graphics processors. Non-core circuitry of a processor or a processor chip may comprise circuitry of a processor or processor chip other than the processing core or cores of the processor or processor chip, such as interconnect circuitry, uncore or system agent circuitry (e.g. any one or more of: higher level cache memory, interconnect controller, on-die memory controller, Thunderbolt™ controller).

The power management circuitry 8 is shown in broken lines in FIG. 1a because it may be circuitry of, or integrated with, the load 2 (e.g. circuitry provided on the same chip, in the same package or on the same integrated circuit die as the load 2), circuitry of or integrated with the voltage regulator 1 (e.g. circuitry provided on the same chip, in the same package or on the same integrated circuit die as the voltage regulator 1), circuitry separate from the voltage regulator 1 and the load 2 (e.g. circuitry provided on a different chip, in a different package, or on a different integrated circuit die from the voltage regulator 1 and the load 2), such as circuitry of an embedded controller, or circuitry distributed between any combination of circuitry of or integrated with the voltage regulator 1, circuitry of or integrated with the load 2 and circuitry separate from the voltage regulator 1 and the load 2.

For example, FIG. 1b shows the power management circuitry 8 being provided by the load power controller 5 of or integrated with the load 2, while FIG. 1c shows the power management circuitry 8 being power management circuitry 8 of or integrated with the voltage regulator 1. In the former case, it may be that the power management circuitry 8 is to control the power state of the voltage regulator 1 by way of power state update commands sent from the power management circuitry 8 to the voltage regulator 1, for example by way of the power management communication interface 6. In the latter case, it may be that the power management circuitry 8 of the voltage regulator 1 is to directly control the power state of the voltage regulator 1. It may be that in the latter case, the power management circuitry 8 of the voltage regulator 1 is operable to override power state update commands sent from the load power controller 5 to the voltage regulator 1.

The power management circuitry 8 may be general purpose processing circuitry or special purpose circuitry. The functionality of the power management circuitry 8 may be implemented in software, firmware, hardware or any combination thereof. It may be that the power management circuitry 8 comprises processing circuitry in communication with a memory, such as a non-transient computer readable memory, the memory storing computer program instructions executable by the processing circuitry of the power management circuitry 8 to perform the functionality of the power management circuitry 8.

The voltage regulator 1 may be a multi-phase voltage regulator capable of providing the output current I_{load} and the regulated voltage V_{reg} to the load based on one phase or on a plurality of phases. For example, the voltage regulator may be a multi-phase voltage regulator capable of combining outputs from each of a plurality of parallel phases to provide the regulated voltage output, V_{reg}, and load current I_{load} to the load 2. It may be that the voltage regulator is operable in a continuous conduction mode and in a discontinuous conduction mode. For example, the voltage regulator 1 may have an on/off cycle to provide the regulated voltage V_{reg} and output current I_{load} to the load 2, the on/off cycle being performed continuously in the continuous conduction mode and discontinuously in the discontinuous conduction mode, the discontinuous on/off cycle being to inhibit power loss when an inductor current goes negative. It may be that the voltage regulator 1 is operable in the discontinuous conduction mode at different switching frequencies. For example, it may be that the voltage regulator is operable in the discontinuous conduction mode at a first switching frequency (e.g. a first switching frequency without pulse skipping or with pulse skipping at a first pulse skipping frequency) and at a second switching frequency lower than the first switching frequency (e.g. with pulse skipping or with pulse skipping at a second pulse skipping frequency greater than the first pulse skipping frequency, i.e. pulses being skipped more often at the second switching frequency).

It may be that the voltage regulator 1 is an external voltage regulator or an internal or integrated voltage regulator. An external voltage regulator may be provided external to the load 2, whereas an internal voltage regulator may be internal to or integrated with the load. For example, an internal voltage regulator may be provided on the same integrated circuit die or on the same chip or in the same package as the load 2. An external voltage regulator may be provided off the integrated circuit die or chip of the load 2 or in a separate package from the load 2.

The voltage regulator 1 may be operable in at least first and second different power states. It may be that a maximum output current capacity of the voltage regulator 1 is different in each of the said power states. It may be that power losses from the voltage regulator 1 are different in different power states. It may be that the first power state is more power efficient than the second power state at a first output loading and that the second power state is more power efficient than the first power state at a second output loading different from the first output loading.

It may be that the first and second power states of the voltage regulator 1 differ from each other by way of any one or more of the following: the voltage regulator operates with different phase counts in the first and second power states; the voltage regulator operates in a continuous conduction mode in one of the first and second power states and the voltage regulator operates in a discontinuous conduction mode in the other of the first and second power states; the voltage regulator operates in a discontinuous conduction mode having a first voltage regulator switching frequency in one of the first and second power states and the voltage regulator operates in a discontinuous conduction mode having a second voltage regulator switching frequency different from the first voltage regulator switching frequency in the other of the first and second power states; one or more circuits of the voltage regulator are inactive or powered off in one of the first and second power states and one or more of the said one or more circuits of the voltage regulator are active or powered on in the other of the first and second power states; one or more circuits of the voltage regulator are in a lower power state in one of the first and second power states and one or more of the said one or more circuits of the voltage regulator are in a higher power state in the other of the first and second power states.

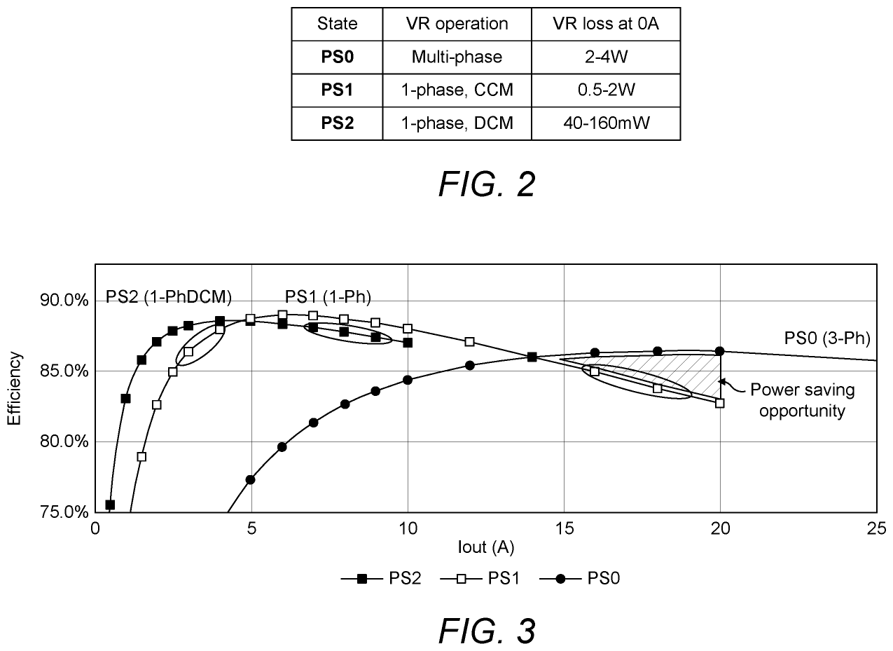

For example, as shown in the table of FIG. 2, it may be that the voltage regulator 1 is operable in three different power states: PS0, PS1 and PS2. In power state PS0, the voltage regulator 1 may be configured to operate in multi-phase mode. For example, it may be that the voltage regulator 1 is configured to supply the output current, Load, and the regulated voltage, V_{reg}, to the load 2 by way of three parallel phases. It may be that, in power state PS0, the voltage regulator 1 is capable of supplying an output current to the load 2 of greater than 20 A. It may be that, in power state PS0, all circuits of the voltage regulator are enabled and the voltage regulator operates in continuous conduction mode. It may be that when no current is drawn from the voltage regulator 1 by the load 2 when the voltage regulator 1 is operating in power state PS0, the power loss from the voltage regulator is between 2 W and 4 W.

In power state PS1, it may be that the voltage regulator 1 is configured to supply the output current, I_{load}, and the regulated voltage, V_{reg}, to the load 2 by way of a single phase in continuous conduction mode. It may be that one or more other phases of the voltage regulator 1 are disabled in power state PS1. It may be that, in power state PS1, the voltage regulator 1 is capable of supplying an output current to the load of up to 20 A. It may be that 20 A is an upper limit of the output current which can be supplied by the voltage regulator 1 to the load 2 in power state PS1. It may be that when no current is drawn from the voltage regulator 1 by the load 2 when the voltage regulator 1 is operating in power state PS1, the power loss from the voltage regulator is between 0.5 W and 2 W.

In power state PS2, it may be that the voltage regulator 1 is configured to supply the output current, Load, and the regulated voltage, V_{reg}, to the load 2 by way of a single phase in discontinuous conduction mode with a first voltage regulator switching frequency f_{sw1}. It may be that one or more other phases of the voltage regulator 1 are disabled in power state PS2. It may be that, in power state PS2, the voltage regulator 1 is capable of supplying an output current to the load of up to 5 A. It may be that 5 A is an upper limit of the output current which can be supplied by the voltage regulator 1 to the load 2 in power state PS2. It may be that when no current is drawn from the voltage regulator 1 by the load 2 when the voltage regulator 1 is operating in power state PS2, the power loss from the voltage regulator is between 40-160 mW.

It will be understood that the voltage regulator 1 may have more or fewer power states than the three power states PS0 to PS2 discussed above. It will also be understood that the power states of the voltage regulator 1 may be defined differently from power states PS0 to PS2 as discussed above.

It may be that the voltage regulator 1 is operable to provide a plurality of different regulated voltages to the load 2 in each of a plurality of different power states of the voltage regulator 1. For example, it may be that the voltage regulator 1 is capable of supplying the same range of regulated voltages to the load 2 in each of a plurality of different power states. It may be that the voltage regulator 1 is capable of supplying a plurality of different output currents to the load 2 in each of a plurality of different power states.

It will be assumed in the discussion below unless stated otherwise that the power management circuitry 8 is provided by the load power controller 5 or by circuitry of or integrated with the voltage regulator 1 (e.g. as shown in FIGS. 1b, 1c). However, as mentioned above, it will be understood that the power management circuitry 8 may be provided by circuitry of, or integrated with, the load 2 (e.g. circuitry provided on the same chip, in the same package or on the same integrated circuit die as the load 2), circuitry of or integrated with the voltage regulator 1 (e.g. circuitry provided on the same chip, in the same package or on the same integrated circuit die as the voltage regulator 1), circuitry separate from the voltage regulator 1 and the load 2 (e.g. circuitry provided on a different chip, in a different package, or on a different integrated circuit die from the voltage regulator 1 and the load 2), such as circuitry of an embedded controller, or circuitry distributed between any combination of circuitry of or integrated with the voltage regulator 1, circuitry of or integrated with the load 2 and circuitry separate from the voltage regulator 1 and the load 2.

It may be that the power management circuitry 8 is to cause the voltage regulator 1 to change between power states, for example by determining output current data relating to (e.g. depending on or indicative of) an output current I_{load} to be provided by the voltage regulator 1 to the load 2 and comparing the determined output current data to power state current threshold data relating to (e.g. depending on or indicative of) an output current level at which the voltage regulator 1 is to change between power states. For example, the determined output current data may comprise or consist of a determined output current to be provided by the voltage regulator 1 to the load 2. For example, the output current data may be based on or comprise or consist of a (e.g. directly) measured current from the voltage regulator 1 to the load 2 or an estimated or predicted current from the voltage regulator 1 to the load 2. The power state current threshold data may comprise or consist of a power state current threshold corresponding to the output current level at which the voltage regulator 1 is to change between power states (e.g. between first and second power states).

For example, it may be that if the determined output current data indicates an output current of greater than or equal to a power state current threshold indicated by the power state current threshold data, the power management circuitry 8 is to cause the voltage regulator 1 to change power state from a lower power state to a higher power state. In this case, it may be that the power state current threshold is an upper current limit of the lower power state of the voltage regulator 1. For example, referring to the power states of FIG. 2, it may be that when the voltage regulator 1 is operating in power state PS1, the power state current threshold is 20 A (i.e. the upper limit of the output current capacity of the voltage regulator 1 operating in PS1). It may be that when the determined output current data indicates an output current to be provided by the voltage regulator 1 to the load 2 of 20 A, the power management circuitry 8 is to cause the voltage regulator 1 to change power states from PS1 to PS0, for example to enable the voltage regulator to supply an output current to the load, Load, of greater than 20 A if later required.

In another example, it may be that if the determined output current data indicates an output current to be provided by the voltage regulator 1 to the load 2 of less than a power state current threshold indicated by the power state current threshold data, it may be that the power management circuitry 8 is to cause the voltage regulator 1 to change power state from a higher power state to a lower power state. In this case, it may be that the power state current threshold is an upper current limit of the lower power state of the voltage regulator 1. For example, referring to the power states of FIG. 2, it may be that when the voltage regulator 1 is operating in power state PS0, it may be that the power state current threshold is 20 A (i.e. the upper limit of the output current capacity of the voltage regulator 1 operating in PS1). It may be that when the determined output current data indicates an output current to be provided by the voltage regulator 1 to the load 2 of less than 20 A, the power management circuitry 8 is to cause the voltage regulator 1 to change power states from PS0 to PS1 with the aim of improving the power efficiency of the voltage regulator 1.

However, it has been determined that the output current levels at which different power states of the voltage regulator 1 become more power efficient than the others may be different from the electrical current limits of the lower power states. FIG. 3 shows plots of the power efficiencies of three of the power states (PS0-PS2) of the voltage regulator 1 defined in FIG. 2 as functions of the output current I_{load} supplied by the voltage regulator 1 to the load 2. It can be seen that, despite the upper current limit of power state PS1 being 20 A, the higher power state PS0 of the voltage regulator 1 is in fact more power efficient than the lower power state PS1 of the voltage regulator 1 when the output current exceeds 14 A. Accordingly, it may be that power state current thresholds relating to the output current levels at which the power management circuitry 8 is to cause the voltage regulator 1 to change between power states are set to be different from (e.g. lower than) the upper current capacity limit of the lower power states. For example, the power state current thresholds may be derived from an analysis of the power efficiencies of the different power states of the voltage regulator 1 as a function of output current I_{load} to be supplied to the load 2. In this way, the power efficiency of the voltage regulator 1 can be improved.

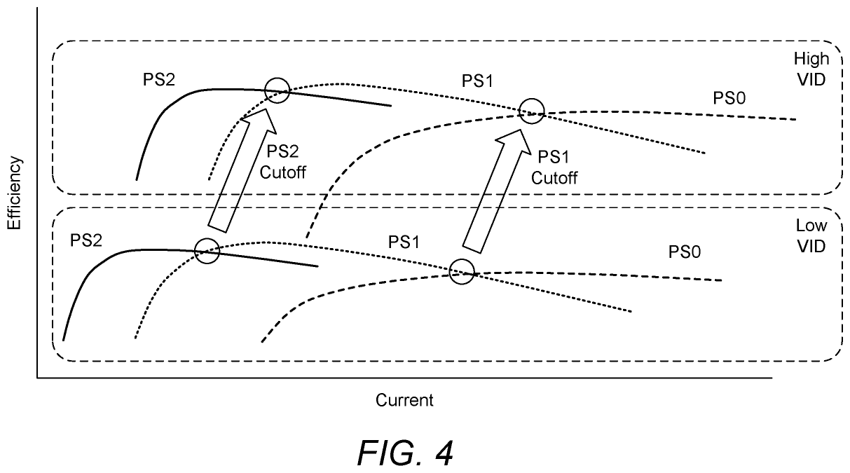

It has been further determined that the output current levels at which different power states of the voltage regulator 1 become more power efficient than the others change depending on the regulated voltage V_{reg} supplied by the voltage regulator 1 to the load 2. This is illustrated by the example of FIG. 4.

FIG. 4 comprises an upper illustrative plot of voltage regulator power efficiency versus the output current I_{load} supplied by the voltage regulator 1 to the load 2 for three different power states (PS0-PS2) of the voltage regulator 1 when the voltage regulator provides a first (higher) regulated voltage to the load 2. FIG. 4 further comprises a lower illustrative plot of voltage regulator power efficiency versus the output current supplied by the voltage regulator 1 to the load 2 for the three different power states (PS0-PS2) of the voltage regulator 1 when the voltage regulator 1 provides a second (lower) regulated voltage to the load 2. It can be seen that the power state current threshold (marked as “PS1 cutoff” in FIG. 4) at which one of the power states PS0 and PS1 becomes more efficient than the other increases with an increased regulated voltage V_{reg} from the voltage regulator 1 to the load 2. Similarly, the power state current threshold (marked as “PS2 cutoff” in FIG. 4) at which one of the power states PS1 and PS2 becomes more efficient than the other also increases with an increased regulated voltage V_{reg} from the voltage regulator 1 to the load 2.

Accordingly, it may be that the power management circuitry 8 is to: determine output current data relating to (e.g. depending on or indicative of) the output current I_{load} to be provided by the voltage regulator 1 to the load 2; determine regulated voltage data relating to (e.g. depending on or indicative of) the regulated voltage V_{reg} to be provided by the voltage regulator 1 to the load 2; determine power state current threshold data relating to (e.g. depending on or indicative of) an output current level at which the voltage regulator is to change between first and second power states of the voltage regulator 1, the power state current threshold data depending on the determined regulated voltage data; and cause a change in the power state of the voltage regulator 1 from the first power state to the second power state based on a comparison of the determined output current data and the determined power state current threshold data. By the power state current threshold data depending on determined regulated voltage data relating to the regulated voltage to be provided by the voltage regulator 1 to the load 2, more accurate power state current threshold data can be determined by way of which to cause a change in the power state of the voltage regulator 1 to the more efficient of the first and second power states. This allows the voltage regulator 1 to operate more power efficiently. It will be understood that the voltage regulator 1 may be capable of providing the said regulated voltage in each of the first and second power states. It may be that the voltage regulator 1 is capable of providing the said output current to the load 2 in each of the first and second power states.

It may be that the determined regulated voltage data comprises or consists of a determined regulated voltage to be provided by the voltage regulator 1 to the load 2.

It may be that the determined regulated voltage data is based on (e.g. comprises or consists of) a voltage demanded, or a voltage to be demanded, from the voltage regulator 1 for the load 2 (e.g. by the load power controller 5).

For example, when the power management circuitry 8 is provided by the load power controller 5 of or integrated with the load 2 (e.g. as shown in FIG. 1b), it may be that the (e.g. processing circuitry of the) power management circuitry 8 is to determine the regulated voltage data relating to the regulated voltage V_{reg} to be provided by the voltage regulator 1 to the load 2 by way of the voltage to be demanded from the voltage regulator 1 for the load 2 by the load power controller 5. For example, the load power controller 5 may be to determine a voltage operating point of the load 2 and to determine the voltage to be demanded for the load 2 from the voltage regulator 1 based thereon. The voltage operating point may be a voltage/frequency operating point of the load 2, such as a voltage/frequency operating point of processing circuitry or a memory controller of the load 2. It may be that the load power controller 5 is to send to the voltage regulator 1 a load voltage demand signal depending on the determined regulated voltage to be demanded from the voltage regulator 1 for the load 2. The load voltage demand signal may comprise a voltage identification, VID, code. It may be that the VID code is indicative of a regulated voltage to be demanded from the voltage regulator 1 for the load 2. The load voltage demand signal may be sent from the load power controller 5 to the voltage regulator 1 by way of the power management communication interface 6.

In another example, for example when the power management circuitry 8 is provided by circuitry of or integrated with the voltage regulator 1 (e.g. as shown in FIG. 1c), it may be that the (e.g. processing circuitry of the) power management circuitry 8 is to determine the regulated voltage data relating to the regulated voltage V_{reg} to be provided by the voltage regulator 1 to the load 2 by way of a received voltage demand for the load 2 such as a load voltage demand received from the load power controller 5. For example, it may be that the regulated voltage data comprises or consists of the voltage demanded for the load 2. For example, the load power controller 5 may send a load voltage demand signal to the power management circuitry 8 which receives the said load voltage demand signal therefrom, the load voltage demand signal indicating a voltage demanded for the load 2 from the voltage regulator 1. For example, the load power controller 5 may determine a voltage (e.g. voltage/frequency) operating point of the load 2 and send a load voltage demand signal to the power management circuitry 8 demanding a voltage for the load 2 depending thereon. The load voltage demand signal may comprise a voltage identification, VID, code indicative of the regulated voltage demanded from the voltage regulator 1 for the load 2. The load voltage demand signal may be received by the power management circuitry 8 by way of the power management communication interface 6.

By determining the regulated voltage data relating to the regulated voltage to be provided by the voltage regulator 1 to the load 2 based on a voltage demanded or a voltage to be demanded for the load 2 from the voltage regulator 2, the regulated voltage to be provided by the voltage regulator 1 to the load 2 can be efficiently determined.

In other examples it may be that the power management circuitry 8 is to determine the regulated voltage data relating to the regulated voltage V_{reg} to be provided by the voltage regulator 1 to the load 2 based on a measured regulated voltage V_{reg} being provided by the voltage regulator 1 to the load 2. For example, it may be that the voltage regulator 1 comprises output voltage measurement circuitry to measure the regulated voltage V_{reg} provided by the voltage regulator 1 to the load 2. In another example, it may be that the load power controller 5 comprises voltage measurement circuitry to measure the regulated voltage V_{reg} provided by the voltage regulator 1 to the load 2. It may be that the measured regulated voltage V_{reg} is communicated to the power management circuitry 8. It may be that the determined regulated voltage data comprises or consists of the measured regulated voltage.

It may be that the output current data relating to the output current to be provided by the voltage regulator 1 to the load 2 comprises or consists of a determined output current to be provided by the voltage regulator 1 to the load 2.

It may be that the (e.g. processing circuitry of the) power management circuitry 8 is to determine the output current data relating to the output current to be provided by the voltage regulator 1 to the load 2 based on a predicted output current to be provided by the voltage regulator 1 to the load 2. For example, it may be that the determined output current data comprises or consists of the predicted output current to be provided by the voltage regulator 1 to the load 2. It may be that the predicted output current is an output current predicted by the load power controller 5. It may be that the predicted output current is a predicted worst case output current which may be provided by the voltage regulator 1 to the load 2. For example, if the load 2 comprises processing circuitry, it may be that the predicted output current is based on an assumption that an application ratio of the processing circuitry of the load is 100% or substantially 100%. The predicted output current may be predicted taking into account one or more further variables relating to the load 2, such as temperature and the voltage operating point of the load 2. The temperature may be obtained by the load power controller 5 from temperature sensing circuitry, while the load power controller 5 may have prior knowledge of the voltage operating point of the load 2, for example because the load power controller 5 may control the voltage operating point of the load 2.

Where the (e.g. processing circuitry of the) power management circuitry 8 is provided by circuitry of or integrated with the voltage regulator 1 (such as shown in FIG. 1c), it may be that the load power controller 5 is to communicate the predicted output current level to the power management circuitry 8, for example by way of the power management communication interface 6.

It may be that the worst-case output current is unlikely to be drawn from the voltage regulator 1 by the load 2 on the basis that real life workloads rarely reach 100% application ratio. If the current to be output by the voltage regulator 1 to the load 2 is predicted inaccurately, it may be that the voltage regulator 1 is controlled to operate in a less power efficient power state than would otherwise be possible. For example, with reference to FIG. 3, if the predicted worst case current which may be output by the voltage regulator 1 to the load 2 is 15 A, it may be that the voltage regulator 1 is controlled by the power management circuitry 8 to operate in power state PS0, but if the actual current output by the voltage regulator 1 to the load 2 is in fact 11 A, it may be that operating in power state PS1 would be more power efficient and therefore preferable.

In order to account for the fact that real life workloads rarely reach 100% application ratio, it may be that the determined power state current threshold data, the predicted current to be output by the voltage regulator 1 to the load 2 or both the determined power state current threshold data and the predicted current to be output by the voltage regulator 1 to the load 2 are scaled by appropriate scaling factors. Different scaling factors may be provided for power state current threshold data relating to changes between different pairs of power states of the voltage regulator 1. For example, referring to the example of FIG. 3, it may be that the power state current threshold data relating to the output current level at which the voltage regulator 1 is to change between power states PS1 and PS0 is scaled (e.g. increased) by a factor of 1.4. It may be that the power state current threshold data relating to the output current level at which the voltage regulator 1 is to change between power states PS2 and PS1 is scaled (e.g. increased) by a factor of 1.2. It will be understood that a similar effect may be achieved by scaling (e.g. reducing) the predicted current to be output by the voltage regulator 1 to the load 2 by similar factors, or any suitable combination of scaling the predicted current and the determined thresholds.

Alternatively, the power management circuitry 8 may be to determine the output current data relating to the output current to be provided by the voltage regulator 1 to the load 2 based on a (e.g. directly) measured output current from the voltage regulator 1 to the load 2. For example, it may be that the determined output current data comprises or consists of the said measured current. It may be that the measured current from the voltage regulator 1 to the load 2 is a current measured by current monitoring circuitry such as current monitoring circuitry of, or integrated with, the voltage regulator 1 or by current monitoring circuitry of, or integrated with, the load 2 (e.g. current monitoring circuitry provided on the same chip, in the same package or on the same integrated circuit die as the voltage regulator 1 or current monitoring circuitry provided on the same chip, in the same package or on the same integrated circuit die as the load 2). It may be that the (e.g. processing circuitry of the) power management circuitry 8 is to determine the output current data relating to the output current to be provided by the voltage regulator 1 to the load 2 by receiving a measured output current of the voltage regulator 1 to the load 2 from the current monitoring circuitry. For example, it may be that current monitoring circuitry, such as current monitoring circuitry of, or integrated with, the voltage regulator 1 is to measure the output current provided by the voltage regulator 1 to the load 2 and to communicate the measured output current to the power management circuitry 8, such as by way of the power management communication interface 6, such as by way of a code.

In the event that (e.g. the processing circuitry of) the power management circuitry 8 is provided by the load power controller 5, and the current monitoring circuitry is circuitry of or integrated with the voltage regulator 1, it may be that there is a slight delay in the power management circuitry 8 receiving the measured output current (e.g. because the output current provided by the voltage regulator to the load may be a reactive result, for example of a utilization and frequency of the load). By providing current monitoring circuitry at, or integrated with, the load 2 for measuring the output current provided by the voltage regulator 1 to the load 2 and communicating the measured output current to the (e.g. processing circuitry of the) power management circuitry 8 therefrom, the measured output current may be communicated more quickly to the (e.g. processing circuitry of the) power management circuitry 8.

By determining the output current data relating to the output current to be provided by the voltage regulator 1 to the load 2 based on a measured output current from the voltage regulator 1 to the load 2, more accurate output current data may be determined, thereby allowing the voltage regulator 1 to be operated more power efficiently. Particularly when the load 2 comprises at least a portion of processor chip, and when (e.g. the processing circuitry of) the power management circuitry 8 is provided on the said processor chip (e.g. by a load power controller 5 thereof), the processor chip can more power efficiently control the power state of the voltage regulator 1, for example without having to provide additional power management circuitry or reconfiguring an existing voltage regulator 1.

It will be understood that improved power efficiency can be obtained by determining the output current data relating to the output current to be provided by the voltage regulator 1 to the load 2 based on a measured output current from the voltage regulator 1 to the load 2 and determining when to cause a change in the power state of the voltage regulator 1 based on a comparison of the said output current data and power state current threshold data, even when the regulated voltage to be provided from the voltage regulator 1 to the load 2 is not taken into account in the determination of the power state current threshold data (e.g. even when the power state current threshold data remains static). It will also be understood that improved power efficiency can be obtained by determining the output current data relating to the output current to be provided by the voltage regulator 1 to the load 2 based on an estimated or predicted output current from the voltage regulator 1 to the load 2 and determining when to cause a change in the power state of the voltage regulator 1 based on a comparison of the said output current data and power state current threshold data when the regulated voltage to be provided from the voltage regulator 1 to the load 2 is taken into account in the determination of the power state current threshold data. However, yet greater improvements in power efficiency can be obtained by determining the output current data relating to the output current to be provided by the voltage regulator 1 to the load 2 based on a measured output current from the voltage regulator 1 to the load 2 and determining when to cause a change in the power state of the voltage regulator 1 based on a comparison of the said output current data and power state current threshold data when the power state current threshold data is determined depending on regulated voltage data relating to the regulated voltage to be provided from the voltage regulator 1 to the load 2.

It may be that the power state current threshold data comprises or consists of the output current level at which the voltage regulator 1 is to change between first and second power states of the voltage regulator 1. It may be that the power state current threshold data is dynamically variable by (e.g. the processing circuitry of) the power management circuitry 8 depending on the determined regulated voltage data. For example, it may be that whilst the load 2 is operating, the (e.g. processing circuitry of the) power management circuitry 8 is to update previously determined power state current threshold data depending on the determined regulated voltage data, for example in response to or depending on a change in the regulated voltage to be provided by the voltage regulator 1 to the load 2 (e.g. a change in the load voltage demand or in the measured regulated voltage supplied by the voltage regulator 1 to the load 2). It may be that the power state current threshold data is different from the previously determined power state current threshold data by virtue of the determined regulated voltage data being different from determined regulated voltage data on which the previously determined power state current threshold data depended. For example, it may be that the determined regulated voltage data on which the previously determined power state current threshold data depended related to a different (e.g. greater or lower) regulated voltage level to be provided by the voltage regulator 1 to the load 2 from the said determined regulated voltage data on which the present power state current threshold data depends (e.g. due to a change in voltage demand from the load 2).

It may be that, for example when the power management circuitry 8 is provided by the load power controller 5 (e.g. as shown in FIG. 1b), the (e.g. processing circuitry of the) power management circuitry 8 is to cause a change in the power state of the voltage regulator 1 by causing a power state update command to be sent, for example from the power management circuitry 8, to the voltage regulator 1. A power state update command may indicate a power state of the voltage regulator 1 to be implemented by the voltage regulator 1. The voltage regulator 1 may be to receive the power state update command from the power management circuitry 8 and depending thereon to change a configuration of the voltage regulator 1 to implement the power state indicated by the power state update command, for example by any one or more of: changing a phase count thereof, enabling or disabling one or more circuits thereof, changing the power mode of one or more circuits thereof, changing between CCM and DCM modes, changing the voltage regulator switching frequency in a DCM mode. For example, it may be that the voltage regulator 1 comprises configuration circuitry to dynamically reconfigure the voltage regulator to thereby change the power state thereof. It may be that the power state update demand received by the voltage regulator 1 causes the voltage regulator configuration circuitry to dynamically reconfigure the voltage regulator 1 from one power state to a different power state.

Alternatively, for example when the (e.g. processing circuitry of the) power management circuitry 8 is provided by circuitry of or integrated with the voltage regulator 1 (e.g. as shown in FIG. 1c), it may be that the power management circuitry 8 is to cause a change in the power state of the voltage regulator 1 by directly causing a change to the configuration of the voltage regulator 1, for example by causing the voltage regulator 1 to change a phase count thereof, enable or disable one or more circuits thereof, change the power mode of one or more circuits thereof, change between CCM and DCM modes, change the voltage regulator switching frequency in a DCM mode. In this case, the voltage regulator 1 can operate more power efficiently (e.g. by operating in its most power efficient power state more often), for example without having to provide additional power management circuitry or having to reconfigure or reprogram power management circuitry outside of the voltage regulator 1 to control the power state of the voltage regulator 1. In addition, further flexibility may be provided in this case on the combinations of phases of the voltage regulator 1 which may be controlled to contribute to the regulated voltage or output current to be provided to the load 2 by the voltage regulator 1. For example, the voltage regulator 1 may be operable to select any possible combination of phases to contribute to the regulated voltage or output current to be provided to the load 2, whereas the load power controller 5 may be operable to request the voltage regulator 1 to operate in a more limited set of defined power states (e.g. the limited set of defined power states may consist of power states using all (of e.g. three or more) phases or a single phase, whereas it may be possible to implement other combinations of phases (e.g. two phases) by the voltage regulator 1). It may be that the power management circuitry 8 of or integrated with the voltage regulator 1 may be configured to over-ride a power state requested by a load power controller 5 in setting the power state of the voltage regulator (for example to implement a more power efficient power state of the voltage regulator).

A dependency of a power state current threshold of the voltage regulator 1 on a regulated voltage to be provided by the voltage regulator 1 to the load 2 may be predetermined, for example for use in determining the power state current threshold data depending on the regulated voltage data. For example, in order to predetermine a dependency of a power state current threshold of the voltage regulator 1 on a regulated voltage to be provided by the voltage regulator 1 to the load 2, the power efficiency of the voltage regulator 1 may be determined, for each of a plurality of power states of the voltage regulator 1 (e.g. for each of two or more power states of the voltage regulator 1), as a function of the output current I_{load} to be provided by the voltage regulator 1 to the load 2 and as a function of a regulated voltage V_{reg} to be provided by the voltage regulator 1 to the load 2. For each of a plurality of regulated voltages to be provided by the voltage regulator 1 to the load 2, a power state current threshold may be determined relating to a level of an output current I_{load} of the voltage regulator 1 to the load 2 at which a first one of the power states of the voltage regulator 1 becomes more power efficient than a second one of the power states of the voltage regulator 1 to supply to the load current I_{load} to the load. Reference data may be determined relating to a dependency of the power state current threshold on the regulated voltage V_{reg} to be provided by the voltage regulator 1 to the load 2. This reference data may then be stored for use by the power management circuitry 8 in determining the power state current threshold data depending on the regulated voltage to be provided by the voltage regulator 1 to the load 2.

For example, in order to predetermine the dependency of a power state current threshold of the voltage regulator 1 on the regulated voltage to be provided by the voltage regulator 1 to the load 2, data processing circuitry may be provided comprising one or more processors, the data processing circuitry to: determine the power efficiency of the voltage regulator for each of a plurality of power states thereof as a function of the output current to be provided by the voltage regulator to the load and as a function of the regulated voltage to be provided by the voltage regulator to the load; for each of a plurality of regulated voltages to be provided by the voltage regulator to the load, determine the power state current threshold; and determine reference data relating to a dependency of the power state current threshold on the regulated voltage to be provided by the voltage regulator to the load. The data processing circuitry may be to determine the power efficiency of the voltage regulator for each of the said plurality of power states thereof as a function of the output current to be provided by the voltage regulator to the load and as a function of a regulated voltage to be provided by the voltage regulator to the load by obtaining (e.g. from a memory) input power efficiency data relating to the power efficiency of the voltage regulator for each of the said plurality of power states thereof as a function of an output current to be provided by the voltage regulator to the load and as a function of a regulated voltage to be provided by the voltage regulator 1 to the load 2. The power efficiency data relating to the power efficiency of the voltage regulator may be obtained by empirically measuring an input power to and an output power from the voltage regulator 1 as a function of different output currents and regulated voltages supplied by the voltage regulator 1 to the load 2 for each of the said power states. The power efficiency of the voltage regulator 1 may be determined by comparing the input power to the output power as a function of different output currents and regulated voltages to the load 2 for each of the said power states. The functionality of the data processing circuitry may be implemented in software, firmware, hardware or any combination thereof. It may be that the data processing circuitry comprises processing circuitry in communication with a memory, such as a non-transient computer readable memory, the memory storing computer program instructions executable by the processing circuitry of the data processing circuitry to perform the functionality of the data processing circuitry.

The reference data may comprise profile data indicative of how power state current threshold changes with the regulated voltage provided by the voltage regulator 1 to the load 2. Alternatively, a function (e.g. a mathematical equation or formula comprising one or more parameters) may be determined which relates power state current threshold data (e.g. which may comprise or consist of a power state current threshold) relating to the output current level at which one power state becomes more efficient than the other(s) to regulated voltage data relating to (e.g. depending on or indicative of) the regulated voltage V_{reg} to be provided by the voltage regulator 1 to the load 2. For example, the reference data may be determined by fitting a (e.g. predetermined) function (e.g. mathematical equation or formula comprising one or more parameters) to power state current threshold data relating to the power state current threshold as a function of regulated voltage data relating to the regulated voltage to be provided by the voltage regulator to the load. The (e.g. fitted) function may be, for example, any one or more of a linear function; a polynomial function; a non-linear function. The reference data may comprise value(s) of one or more parameters of the (e.g. fitted) function. The reference data may be stored in a memory accessible to processing circuitry of the power management circuitry 8. For example, the reference data may be stored in a memory of the power management circuitry 8. For example, the reference data may be stored in one or more registers of the power management circuitry 8 or accessible to the processing circuitry of the power management circuitry 8. The said register(s) may be dedicated registers for the said reference data (e.g. which may comprise value(s) of one or more parameters of a function as discussed). This is illustrated in the example of FIG. 9 which is a block diagram schematically illustrating the power management circuitry 8 comprising processing circuitry 8a and registers 8b, 8c accessible thereto. The reference data stored in the memory (e.g. registers 8b, 8c) may be programmable by way of software or firmware, such as by way of a BIOS (basic input output system) for controlling the power management circuitry 8 (e.g. a BIOS of the load where the power management circuitry 8 or at least the said memory is provided by circuitry of or integrated with the load 2 such as by a load power controller 5).

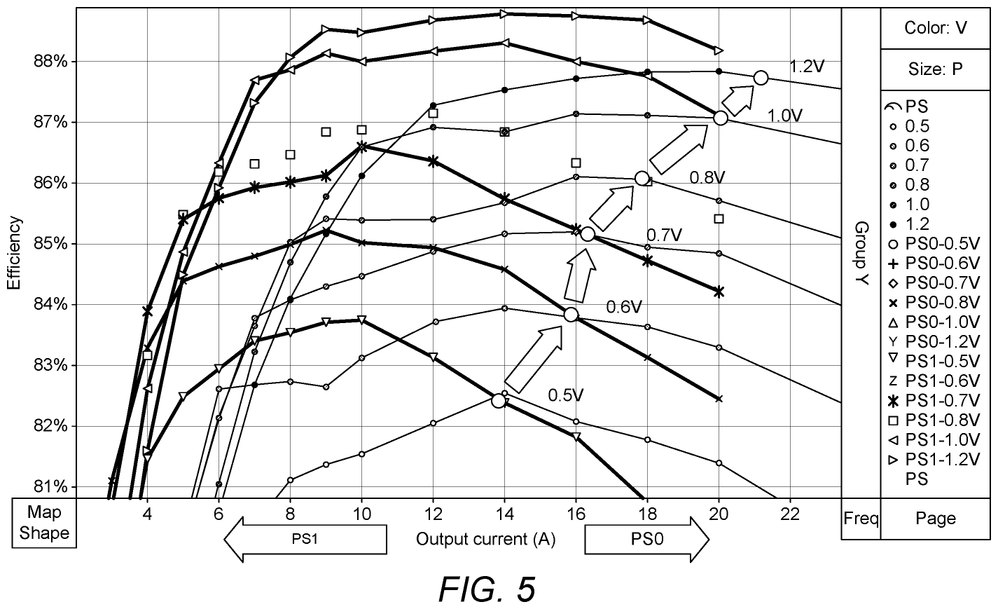

An illustrative example of predetermining the dependency of a power state current threshold of the voltage regulator 1 on a regulated voltage to be provided by the voltage regulator 1 to the load 2 is provided with reference to FIG. 5.

FIG. 5 shows plots of power efficiency of the voltage regulator 1 as a function of output current I_{load} to be provided by the voltage regulator 1 to the load 2 for each of power states PS0 and PS1 for each of the following plurality of regulated voltages V_{reg} provided by the voltage regulator 1 to the load 2: 0.5V, 0.6V, 0.7V, 0.8V, 1.0V and 1.2V. The thicker lines in each case represent the power efficiency versus output current plot for lower power state PS1 and the corresponding thinner lines represent the power efficiency versus output current plot for the higher power state PS0. Consistent with FIG. 4, the power state current threshold at which one of the two power states PS0 and PS1 of the voltage regulator 1 becomes more efficient than the other (i.e. where the power efficiency curve for power state PS0 crosses the power efficiency curve for power state PS1 for a given regulated voltage to be provided by the voltage regulator 1 to the load 2) increases with increasing regulated voltage provided by the voltage regulator 1 to the load 2. For example, when the voltage regulator 1 provides a regulated voltage to the load 2 of 0.5V, the power state current threshold at which one of the power states PS0 and PS1 becomes more power efficient than the other is approximately 14 A; when the voltage regulator 1 provides a regulated voltage to the load 2 of 1.0V, the power state current threshold at which one of the power states becomes more power efficient than the other is approximately 20 A.

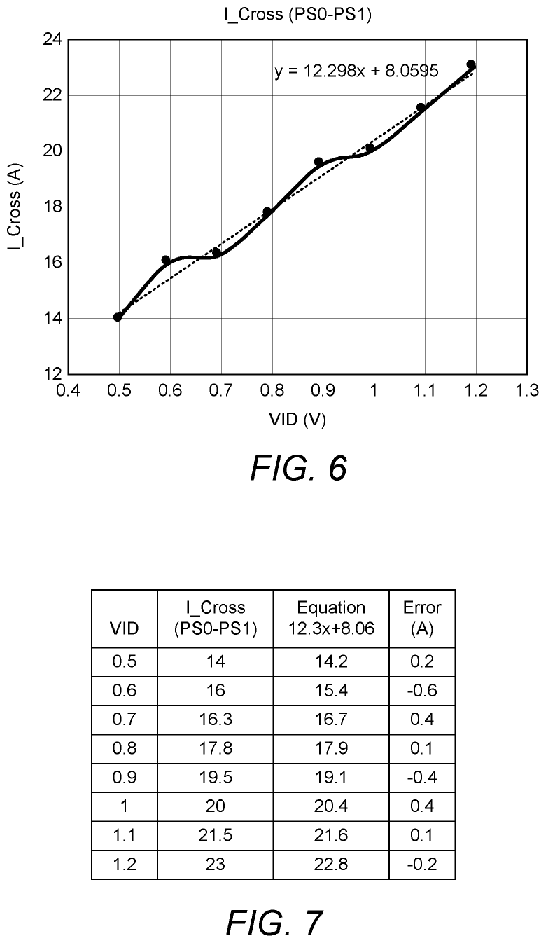

An example plot of the power state current threshold (referred to as I_cross in FIG. 6) at which one of the power states PS0, PS1 of the voltage regulator 1 becomes more efficient than the other as a function of the regulated voltage V_{reg} from the voltage regulator 1 to the load 2 is shown in FIG. 6. Reference data relating to a dependency of the power state current threshold on the regulated voltage provided by the voltage regulator 1 to the load 2 may be stored in a memory accessible to the processing circuitry of the power management circuitry 8, such as memory of power management circuitry 8, for use by the power management circuitry 8 in determining the power state current threshold data depending on the regulated voltage data. For example, as mentioned above, the reference data may comprise profile data indicative of how the power state current threshold varies with the regulated voltage, V_{reg}, from the voltage regulator 1 to the load 2. Alternatively, the reference data may comprise value(s) of one or more parameters of a (e.g. predetermined) function (e.g. mathematical equation or formula comprising one or more parameters) which relates power state current threshold data relating to the output current level at which to change the power state of the voltage regulator to regulated voltage data relating to the regulated voltage V_{reg} provided by the voltage regulator 1 to the load 2. It may be that the value(s) of one or more parameters of the said function are stored in one or more registers accessible to processing circuitry of the power management circuitry 8 such as in one or more registers of the power management circuitry. As discussed above, the function may be any one or more of a linear function; a polynomial function; a non-linear function.

For example, the function may be a function relating the power state current threshold to the regulated voltage data, such as a (e.g. best fit) straight line function (e.g. a mathematical formula or equation representing a straight line) taking the form y=mx+c, where y is the power state current threshold, x is a regulated voltage variable based on the regulated voltage data relating to the regulated voltage to be provided by the voltage regulator 1 to the load 2, m is the gradient of the straight line function and c is the y intercept of the straight line function. For example, in the example of FIG. 6, the regulated voltage variable x may be a determined regulated voltage to be provided by the voltage regulator 1 to the load 2 and the function relating the power state current threshold to the regulated voltage data may be a (e.g. best fit) straight line function y=12.298x+8.0595, where y is the power state current threshold, x is the determined regulated voltage to be provided by the voltage regulator 1 to the load 2, 12.298 is the gradient parameter of the straight line function and 8.0595 is the y intercept parameter of the straight line function. It may be that the reference data stored for the said function comprises values of the gradient parameter m (in the illustrative example of FIG. 6: 12.298) and the y-axis intercept parameter (in the illustrative example of FIG. 6: 8.0595). A first register accessible to processing circuitry of the power management circuitry 8 (such as a first register of the power management circuitry) may store the predetermined value of the gradient parameter, m. A second register accessible to processing circuitry of the power management circuitry 8 (such as a second register of the power management circuitry) may store the value of the y-intercept parameter, c.

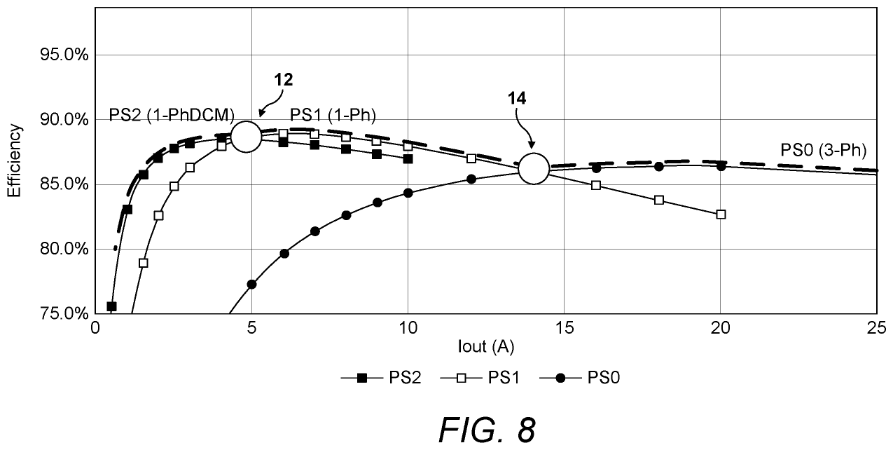

The table of FIG. 7 shows that the error in the power state current threshold derived from the (e.g. best fit) straight line function of FIG. 6 is minimal (less than 0.6 A or less than 3.7%). However, the storage requirements for values of the gradient parameter and the y-axis intercept parameter are significantly less than the storage requirements for (e.g. raw) profile data indicative of the variation in the power state threshold current with the regulated voltage to be provided by the voltage regulator 1 to the load 2. Thus, by storing value(s) of one or more parameters of the said function for determining the power state current threshold, the reference data can be stored efficiently.

The function representing the variation in the power state current threshold data with respect to the regulated voltage data can be any other type of function as appropriate to fit the determined variation of the power state current threshold data with the regulated voltage data. For example, the function may be a polynomial function, a non-linear function or other type of suitable function. It may be that the value(s) of the parameter(s) of the reference data stored in the said memory (where provided) are value(s) of the parameter(s) of the respective function.

It may be that the power state current thresholds between different pairs of power states of the voltage regulator 1 vary differently from each other as a function of the regulated voltage provided by the voltage regulator 1 to the load 2. Accordingly, the process of deriving and storing reference data relating to a dependency of the power state current threshold on the regulated voltage provided by the voltage regulator 1 to the load 2 may be repeated for power state current thresholds between different pairs of power states of the voltage regulator 1. For example, with reference to the example of FIG. 4, the process of deriving and storing reference data relating to a dependency of the power state current threshold data with the regulated voltage data may be performed for the power state current threshold at which the voltage regulator 1 is to change between power states PS1 and PS0 (referred to as “PS1 cutoff” in FIG. 4) and for the power state current threshold at which the voltage regulator 1 is to change between power states PS1 and PS2 (referred to as “PS2 cutoff” in FIG. 4). It may be that different reference data is stored in the said memory 8 accessible to processing circuitry of the power management circuitry 8 for the determination of power state current thresholds between different pairs of power states of the voltage regulator 1.

Thus, in order to determine dependencies of different power state current thresholds at which the voltage regulator 1 is to change between different pairs of power states, a power efficiency of the voltage regulator 1 for each of a plurality of power states thereof (e.g. for each of three or more power states of the voltage regulator 1) may be determined as a function of the output current I_{load} to be provided by the voltage regulator 1 to the load 2 and as a function of a regulated voltage V_{reg} to be provided by the voltage regulator 1 to the load 2. For each of a plurality of regulated voltages to be provided by the voltage regulator 1 to the load 2, for each of a plurality of pairs of power states of the voltage regulator 1, a power state current threshold relating to a level of the output current I_{load} of the voltage regulator 1 to the load 2 at which one power state of the said pair becomes more power efficient than the other may be determined; and for each of a plurality of power state current thresholds relating to output current levels at which the voltage regulator is to change between a respective pair of power states, reference data relating to a dependency of the respective power state current threshold on the regulated voltage may be determined. As above, the reference data may comprise profile data relating to dependencies of the respective power state current thresholds on the regulated voltage to be provided by the voltage regulator 1 to the load 2. Alternatively, functions (e.g. mathematical equations or formulae comprising one or more parameters) may be determined which relate the respective power state current thresholds to the regulated voltage V_{reg} to be provided by the voltage regulator 1 to the load 2. Each of the functions may be any one or more of a linear function; a polynomial function; a non-linear function. The reference data may comprise value(s) of one or more parameters of the said functions. The reference data may then be stored in a memory, such as a memory (e.g. one or more registers) accessible to processing circuitry of power management circuitry 8, such as a memory (e.g. one or more registers) of power management circuitry 8, such as for use by the power management circuitry 8 to determine when the voltage regulator 1 is to change power state.

It may be that the reference data is specific to a type of the voltage regulator 1. It may be that the reference data is specific to a type of the load 2.

As discussed above, it may be that the (e.g. processing circuitry of the) power management circuitry 8 is to: determine output current data relating to the output current I_{load} to be provided by the voltage regulator 1 to the load 2; determine regulated voltage data relating to the regulated voltage V_{reg} to be provided by the voltage regulator 1 to the load 2; determine power state current threshold data relating to an output current level at which the voltage regulator 1 is to change between first and second power states, the power state current threshold data depending on the determined regulated voltage data; and cause a change in the power state of the voltage regulator from the first power state to the second power state based on a comparison of the determined output current data and the determined power state current threshold data. It may be that the (e.g. processing circuitry of the) power management circuitry 8 is to determine the power state current threshold data further depending on predetermined reference data, which may be predetermined reference data stored in memory (such as a memory of the power management circuitry 8 or a memory accessible to processing circuitry of the power management circuitry 8), relating to a dependency of the power state current threshold data on the regulated voltage data relating to the regulated voltage to be provided by the voltage regulator 1 to the load 2. It may be that the (e.g. processing circuitry of the) power management circuitry 8 is to retrieve the said reference data from the said memory to determine the power state current threshold data depending thereon. For example, as discussed above, it may be that the (e.g. processing circuitry of the) power management circuitry 8 is to retrieve value(s) of one or more parameters of a (e.g. predetermined) function (e.g. a function such as a mathematical equation or formula relating the power state current threshold data to the regulated voltage to be provided by the voltage regulator 1 to the load 2) from memory (e.g. one or more registers) and to determine the power state current threshold data depending on the retrieved value(s) of the one or more parameters of the said function, the said (e.g. predetermined) function and the determined regulated voltage data relating to the regulated voltage to be provided by the voltage regulator 1 to the load 2. For example, the processing circuitry of the power management circuitry 8 may be configured to determine the power state current threshold data based on a straight line function (e.g. y=mx+c), which may be a predetermined function, values of the parameters (e.g. m and c) of the straight line function, which may be predetermined values retrieved from memory, and the regulated voltage data relating to the regulated voltage to be provided by the voltage regulator 1 to the load 2.

As mentioned above, it may be that different predetermined reference data may be derived and stored for power state thresholds at which the voltage regulator 1 is to change between different pairs of power states of the voltage regulator 1. The power management circuitry 8 may thus be to determine first power state current threshold data relating to (e.g. depending on or indicative of) an output current level at which the voltage regulator 1 is to change between first and second power states depending on first determined regulated voltage data relating to a first regulated voltage to be provided by the voltage regulator 1 to the load 2 and on first reference data relating to a dependency of the first power state current threshold data on the first determined regulated voltage data, the first reference data being specific to the power state current threshold data relating to the output current level at which the voltage regulator 1 is to change between the first and second power states power states. The power management circuitry 8 may be further to determine second power state current threshold data relating to (e.g. depending on or indicative of) an output current level at which the voltage regulator 1 is to change between the second power state and a third power state depending on second determined regulated voltage data relating to a second regulated voltage to be provided by the voltage regulator 1 to the load 2 and on second reference data relating to a dependency of the second power state current threshold data on the second determined regulated voltage data, the second reference data being specific to the power state current threshold data relating to the output current level at which the voltage regulator 1 is to change between the second and third power states power states.

In an illustrative example, with reference to FIG. 8, it may be that the voltage regulator 1 is in power state PS2. It may be that the (e.g. processing circuitry of the) power management circuitry 8 is to determine regulated voltage data relating to the regulated voltage V_{reg} to be provided by the voltage regulator 1 to the load 2. It may be that the (e.g. processing circuitry of the) power management circuitry 8 is to determine a power state current threshold 12 relating to an output current level at which the voltage regulator 1 is to change from lower power state PS2 to higher power state PS1 depending on the determined regulated voltage data. It may be that the (e.g. processing circuitry of the) power management circuitry 8 is to determine the power state current threshold 12 relating to the output current level at which the voltage regulator 1 is to change from lower power state PS2 to higher power state PS1 further depending on reference data relating to a dependency of the power state current threshold on the regulated voltage data. The reference data may be specific to the power state current threshold relating to the output current level at which the voltage regulator 1 is to change between the power states PS2 and PS1. It may be that the (e.g. processing circuitry of the) power management circuitry 8 is to determine output current data relating to an output current I_{load} to be provided from the voltage regulator 1 to the load 2. It may be that the (e.g. processing circuitry of the) power management circuitry 8 is to compare the determined output current data to the determined power state current threshold. Based on this comparison (e.g. if the determined output current data indicates an output current greater than or equal to the determined power state current threshold) it may be that the (e.g. processing circuitry of the) power management circuitry 8 is to cause the voltage regulator 1 to change power states from PS2 to PS1.

Similarly, when the voltage regulator 1 is in power state PS1, it may be that the (e.g. processing circuitry of the) power management circuitry 8 is to determine second regulated voltage data relating to a second regulated voltage V_{reg} to be provided by the voltage regulator 1 to the load 2. It may be that the (e.g. processing circuitry of the) power management circuitry 8 is to determine a second power state current threshold 14 relating to an output current level at which the voltage regulator 1 is to change from lower power state PS1 to higher power state PS0 depending on the second determined regulated voltage data. It may be that the (e.g. processing circuitry of the) power management circuitry 8 is to determine the power state current threshold 12 relating to the output current level at which the voltage regulator 1 is to change from lower power state PS1 to higher power state PS0 further depending on reference data relating to the dependency of the power state current threshold on the regulated voltage data. The reference data may be specific to the power state current threshold relating to the output current level at which the voltage regulator 1 is to change between the power states PS1 and PS0. The reference data specific to the power state current threshold relating to the output current level at which the voltage regulator 1 is to change between the power states PS1 and PS0 may be different from the reference data specific to the power state current threshold relating to the output current level at which the voltage regulator 1 is to change between the power states PS2 and PS1. It may be that the (e.g. processing circuitry of the) power management circuitry 8 is to determine second output current data relating to a second output current I_{load} to be provided by the voltage regulator 1 to the load 2. It may be that the (e.g. processing circuitry of the) power management circuitry 8 is to compare the second determined output current data to the second determined power state current threshold 14. Based on this comparison (e.g. if the second determined output current data indicates an output current greater than or equal to the second determined power state current threshold) it may be that the (e.g. processing circuitry of the) power management circuitry 8 is to cause the voltage regulator 1 to change power states from PS1 to PS0.

The (e.g. processing circuitry of the) power management circuitry 8 may be configured to cause the voltage regulator 1 to change from a higher power state (e.g. PS0 or PS1) to a lower power state (e.g. PS1 or PS2) in a similar way, for example depending on a determination that determined output current data relating to the output current I_{load} to be provided by the voltage regulator 1 to the load 2 indicates an output current less than the relevant power state current threshold, which threshold again may be determined depending on determined regulated voltage data relating to a regulated voltage to be provided by the voltage regulator 1 to the load 2.

It will be understood that, as discussed, the power state current threshold in each case may be determined further depending on stored predetermined reference data relating to the dependency of the power state current threshold on the determined regulated voltage data relating to the regulated voltage to be provided by the voltage regulator 1 to the load 2, such as stored reference data specific to the dependency of the said power state current threshold on the regulated voltage data relating to the regulated voltage to be supplied to the load 2 by the voltage regulator 1.

It will be understood that if the voltage regulator 1 is already in the appropriate (e.g. most power efficient) power state for the determined output current data, it may be that the power state of the voltage regulator 1 is unchanged.

As indicated by the thicker broken line in FIG. 8, the voltage regulator 1 can thus be operated in the most power efficient power state for the particular determined output current and regulated voltage data.

Hysteresis may be applied in order to inhibit unstable switching between power states, such as by providing power state current threshold data by way of which the (e.g. processing circuitry of the) power management circuitry 8 is to cause a change from a lower power state to a higher power state which is different from the power state current threshold data by way of which the (e.g. processing circuitry of the) power management circuitry 8 is to cause a change from the higher power state to the lower power state. This may be done, for example, by adding or subtracting a nominal value to or from the power state current threshold data for causing a change from the lower power state to the higher power state or to or from the power state current threshold data for causing a change from the higher power state to the lower power state.

A plurality of voltage regulators may be provided for supplying respective regulated voltages to respective loads, the voltage regulators each being operable in at least respective first and second different power states. In this case, it may be that (e.g. the processing circuitry of) the power management circuitry 8 is to, for each of the voltage regulators: determine respective output current data relating to a respective output current to be provided by the respective voltage regulator to the respective load; determine respective regulated voltage data relating to a respective regulated voltage to be provided by the respective voltage regulator to the respective load; determine respective power state current threshold data relating to a respective output current level at which the respective voltage regulator is to change between the respective first and second power states, the respective power state current threshold data depending on the respective determined regulated voltage data; and cause a change in the power state of the respective voltage regulator from the respective first power state to the respective second power state based on a comparison of the respective determined output current data and the respective determined power state current threshold data.

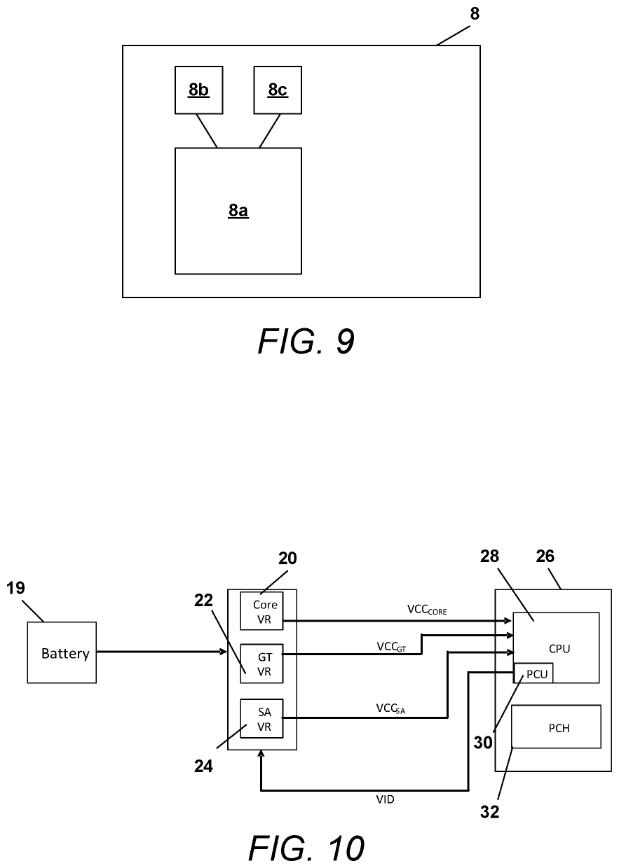

FIG. 10 provides an illustrative example in which a battery 19 powers three voltage regulators 20, 22, 24 each to provide a respective regulated voltage to a respective load. The loads of the voltage regulators 20, 22, 24 are each circuitry of a system-on-chip 26. In particular, the first voltage regulator 20 is to provide a regulated voltage VCC_{CORE} to a multi-core central processing unit (CPU) 28 of the system-on-chip 26, the second voltage regulator 22 is to provide a regulated voltage VCC_{GT} to graphics processing circuitry of the system-on-chip 26 and the third voltage regulator 24 is to provide a regulated voltage VCC_{SA} to system agent circuitry of the system-on-chip 26. The power management circuitry 8 in this case may be provided by a load power control unit (PCU) 30 of the system-on-chip 26. The load power control unit 30 may be to communicate with the voltage regulators 20, 22, 24 by way of a power management communication interface (e.g. a VID bus), for example to communicate load voltage demand signals and power state update commands to the voltage regulators 20, 22, 24. The PCU 30 may also receive measured output currents from the voltage regulators 20, 22, 24 to the corresponding loads by way of the power management communication interface (which may be bi-directional). The PCU 30 may receive measured output voltages from the voltage regulators 20, 22, 24 to the corresponding loads. The system-on-chip 30 may further comprise a platform controller hub (PCH) 32 connected to the central processing unit thereof, for example by way of a direct media interface. One or more voltage regulators may be provided to supply a regulated voltage to the PCH or one or more regulated voltages to one or more components thereof such as an input/output controller thereof. Such voltage regulators may operate in a similar way to regulators 1, 20, 22, 24 discussed herein.

It will be understood that the respective regulated voltage data relating to the respective regulated voltages to be provided by the respective voltage regulators 20, 22, 24 to the respective loads, the respective output current data relating to the respective output currents to be provided by the respective voltage regulators to the respective loads and the respective power state current threshold data may be determined by any of the ways disclosed herein. It will also be understood that changes in the power states of the respective voltage regulators may be caused by any of the ways disclosed herein.

It will also be understood that (e.g. multi-phase) voltage regulators configured to supply regulated voltages to any other suitable loads may be operated more efficiently using the techniques disclosed herein, such as one or more components of a computer platform (such as a memory controller or one or more displays thereof), and in particular loads which demand variable voltage levels from (e.g. multi-phase) voltage regulators. In examples where the load being supplied by the voltage regulator lacks a load power control unit, it may be that the power management circuitry 8 is comprised by circuitry of or integrated with the voltage regulator 1 to determine the relevant power state current threshold data (e.g. depending on a measured regulated voltage being provided to the load) and to cause a change in the power state of the voltage regulator 1, for example depending on a comparison of determined output current data relating to an output current from the voltage regulator 1 to the load 2 and the power state current threshold data, for example by enabling or disabling one or more phases of the voltage regulator or by changing the voltage regulator between CCM and DCM modes (or in any other suitable way, such as in any other suitable way disclosed herein).

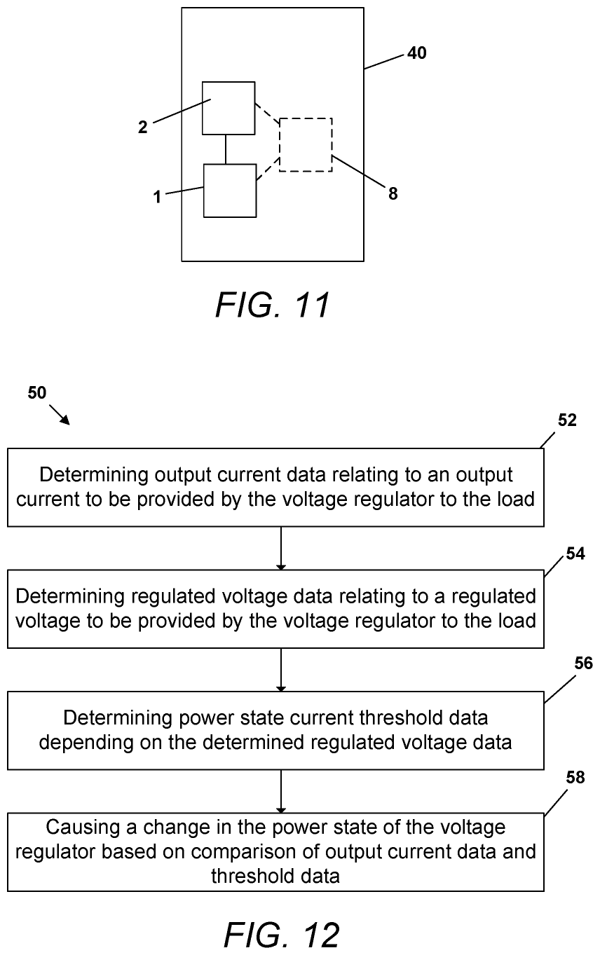

FIG. 11 shows an apparatus 40 comprising the voltage regulator 1 coupled to the load 2, in order to provide a regulated voltage V_{reg} and an output load current I_{load} thereto, and power management circuitry 8. As mentioned, the power management circuitry 8 may be circuitry of or integrated with the load 2 (e.g. circuitry provided on the same chip or integrated circuit die or in the same package as the load 2), circuitry of or integrated with the voltage regulator 1 (e.g. circuitry provided on the same chip or integrated circuit die or in the same package as the voltage regulator 1), circuitry separate from the voltage regulator 1 and the load 2, or circuitry distributed between any combination of circuitry of or integrated with the voltage regulator 1, the load 2 and circuitry separate from the voltage regulator 1 and the load 2. The apparatus 40 may comprise a computing device such as a desktop computer, a laptop computer, a portable computing device, a smartphone, a tablet or phablet computer, a personal data assistant, a wearable computing device or any other suitable computing device. The load 2 may comprise any one or more of: a load of the computing device; a computing platform of the computing device; one or more components of a computing platform (e.g. one or more processors, one or more processor chips, multicore processing circuitry, at least one domain of a multi-core processing circuitry, such as a domain comprising one or more processing cores, or a fan or a display of a computer platform) of the computing device; one or more processors of the computing device; one or more processor chips of the computing device; circuitry of a processor or processor chip of the computing device; processing or computing circuitry of a processor or processor chip of the computing device; one or more domains of a processor chip of the computing device, such as a domain comprising one or more cores of a multi-core processor of the computing device; processing circuitry of a central processing unit of a processor chip of the computing device, such as one or more central processing unit cores; graphics processing circuitry of a processor chip of the computing device, such as one or more graphics processor cores; at least a first domain of multi-core processing circuitry of the computing device further comprising a second domain including at least graphics processing circuitry, the first domain including one or more processing cores, such as one or more processing cores of a central processing unit processor of the computing device; a memory controller of the computing device; a display controller of the computing device; non-core circuitry of a processor or processor chip of the computing device.

It may be that the processor chip, where provided, comprises a dedicated central processing unit chip (such as a dedicated central processing unit chip for a personal computer, such as a desktop personal computer) or a system on chip, SoC, comprising one or more processors, such as one or more central processing unit processors and one or more graphics processors. Non-core circuitry of a processor or a processor chip may comprise circuitry of a processor or processor chip other than the processing core or cores of the processor or processor chip, such as interconnect circuitry, uncore or system agent circuitry (e.g. higher level cache memory, interconnect controller, on-die memory controller, Thunderbolt™ controller).

In one example, the apparatus 40 is a computing platform comprising multi-core processing circuitry including: a first domain including one or more cores and a second domain including at least graphics processing circuitry. It may be that the load comprises at least the first domain. In this case, it may be that the voltage regulator 1 is to provide a regulated voltage to at least the first domain. It may be that the voltage regulator 1 is to provide an output current to at least the first domain. It may be that the power management circuitry 8 is to determine output current data relating to an output current to be provided by the voltage regulator 1 to the said at least first domain; determine regulated voltage data relating to a regulated voltage to be provided by the voltage regulator to the said at least first domain; determine power state current threshold data relating to an output current level at which the voltage regulator is to dynamically reconfigure from the first power state to the second power state, the power state current threshold data depending on the determined regulated voltage data; and cause the voltage regulator to change from the first power state to the second power state based on a comparison of the determined output current data and the determined power state current threshold data.

FIG. 12 is a flow-chart of a method 50 of controlling a power state of a voltage regulator (such as voltage regulator 1) for providing a regulated voltage to a load (such as the load 2), the voltage regulator being operable in at least first and second different power states. The method may be performed by (e.g. processing circuitry of) power management circuitry, such as power management circuitry 8. The functionality of the method may be implemented in software, firmware, hardware or any combination thereof.

The method may comprise, at 52, determining output current data relating to an output current to be provided by the voltage regulator to the load. The method may comprise determining the output current data relating to the output current to be provided by the voltage regulator to the load in any suitable way, such as in any of the ways described herein, such as based on a predicted output current to be provided by the voltage regulator to the load or based on a measured output current from the voltage regulator to the load.

The method may comprise, at 54, determining regulated voltage data relating to a regulated voltage to be provided by the voltage regulator to the load. The method may comprise determining the regulated voltage data relating to the regulated voltage to be provided by the voltage regulator to the load in any suitable way, such as in any of the ways described herein, such as by determining a voltage (e.g. a voltage/frequency) operating point of the load 2 and determining a voltage to be demanded for the load from the voltage regulator 1 based thereon, or by way of a received voltage demand for the load 2, or based on a measured voltage from the voltage regulator to the load.

The method may comprise, at 56, determining power state current threshold data relating to an output current level at which the voltage regulator is to change between the first and second power states, the power state current threshold data depending on the determined regulated voltage data. For example, the method may comprise determining the power state current threshold data relating to an output current level at which the voltage regulator is to change between the first and second power states depending on the determined regulated voltage data and on predetermined reference data relating to a dependence of the power state current threshold data on the regulated voltage data. The method may further comprise retrieving the said reference data from a memory (e.g. one or more registers). For example, the reference data may comprise value(s) of one or more parameters of a predetermined function indicative of the dependency of the power state current threshold data on the regulated voltage data. In this case, the method may comprise determining the power state current threshold data relating to the output current level at which the voltage regulator is to change between the first and second power states depending on the said value(s) of the said parameter(s) of the said function, the said function and the determined regulated voltage data.

The method may comprise, at 58, causing a change in the power state of the voltage regulator from the first power state to the second power state based on a comparison of the determined output current data and the determined power state current threshold data. For example, the method may comprise causing a change in the power state of the voltage regulator from the first power state to the second power state based on the determined output current data indicating an output current greater than or equal to the power state current threshold data, or being less than the power state current threshold data. The method may comprise causing the said change in the power state of the voltage regulator by causing a power state update command to be sent to the voltage regulator. Alternatively, the method may comprise causing the said change in the power state of the voltage regulator by (e.g. directly) reconfiguring the voltage regulator to change a power state thereof.

By the power state current threshold data relating to the output current level at which the voltage regulator is to change between the first and second states depending on the determined regulated voltage data relating to the regulated voltage to be provided by the voltage regulator to the load, more accurate power state current threshold data can be determined at which to change the power state of the voltage regulator to the more efficient of the first and second power states. This allows the voltage regulator to operate more power efficiently.

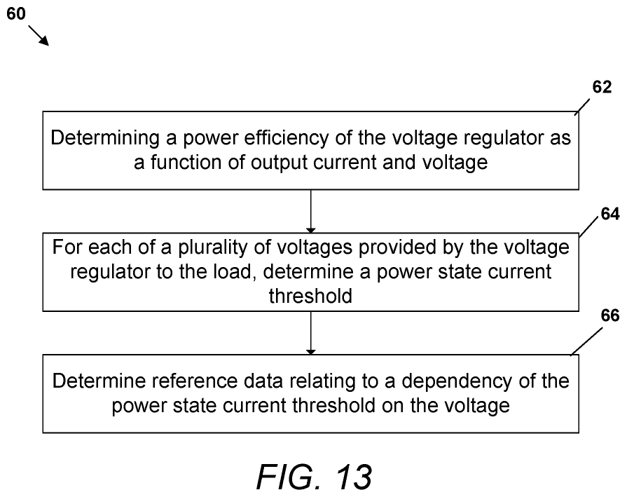

FIG. 13 is a flow-chart of a method 60 of determining a dependency of a power state current threshold of a voltage regulator (such as the voltage regulator 1) on a regulated voltage to be provided by the voltage regulator to a load (such as the load 2), the voltage regulator being operable in a plurality of different power states. The method of FIG. 13 may be performed by data processing circuitry comprising one or more processors. The functionality of the method may be implemented in software, firmware, hardware or any combination thereof.

The method may comprise, at 62, determining a power efficiency of the voltage regulator for each of a plurality of power states of thereof as a function of an output current to be provided by the voltage regulator to the load and as a function of a regulated voltage to be provided by the voltage regulator to the load.

The method may comprise, at 64, for each of a plurality of regulated voltages to be provided by the voltage regulator to the load, determining a power state current threshold relating to a level of an output current of the voltage regulator to the load at which a first power state of the voltage regulator becomes more power efficient than a second power state of the voltage regulator.

The method may comprise, at 66, determining reference data relating to a dependency of the power state current threshold on the regulated voltage to be provided by the voltage regulator 1 to the load 2. The method may further comprise storing the said reference data in memory, such as memory accessible to processing circuitry of the power management circuitry. For example, the method may comprise determining a function (e.g. a mathematical formula or equation comprising one or more parameters) relating power state current threshold data to regulated voltage data relating to the regulated voltage to be provided by the voltage regulator to the load. In this case, it may be that the reference data comprises value(s) of one or more parameters of the said function. In this case, it may be that the method comprises storing the said value(s) of the one or more parameters of the said function in one or more registers, such as in one or more registers accessible to processing circuitry of the power management circuitry such as one or more registers of power management circuitry. By storing value(s) of one or more parameters of a function for determining the power state current threshold data, the reference data can be stored efficiently.

In this way, reference data can be derived for dynamically updating power state current threshold data relating to an output current level at which a voltage regulator 1 is to change between different power states based on the regulated voltage to be provided by the voltage regulator to a load. Thus, the power state of the voltage regulator can be controlled more power efficiently, allowing power savings to be made.

It may be that the reference data is specific to a type of the voltage regulator 1. It may be that the reference data is specific to a type of the load 2. It may be that the reference data is specific to the power state current threshold data by way of which the voltage regulator is to change between the first and second power states. It may be that 62-66 are repeated for power state current threshold data by way of which the voltage regulator 1 is to change between different pairs of power states. It may be that such reference data is stored as discussed.

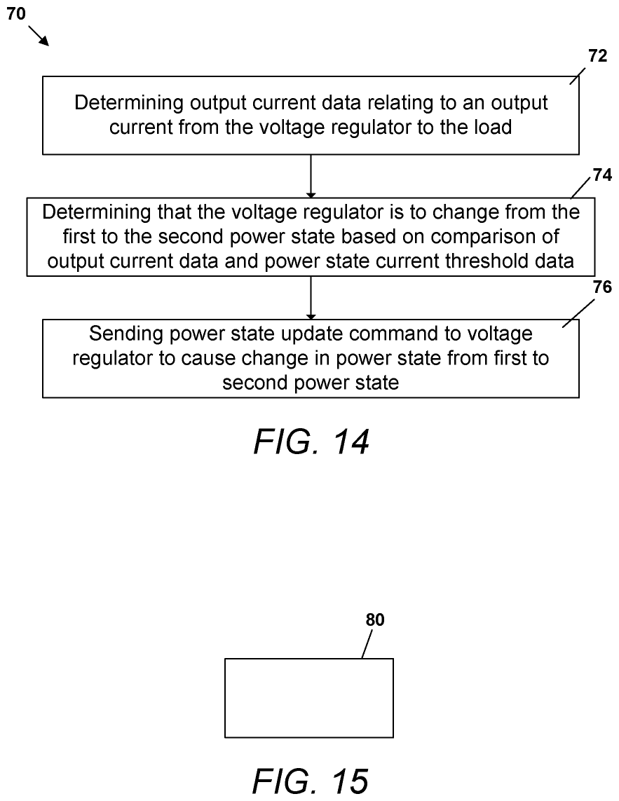

FIG. 14 is a flow-chart of a method 70 of controlling a power state of a voltage regulator (such as voltage regulator 1) for providing a regulated voltage to a load (such as the load 2), the voltage regulator being operable in at least first and second different power states. The method may be performed by power management circuitry of a processor chip, such as power management circuitry of a dedicated central processing unit chip or a system-on-chip comprising one or more processors. The functionality of the method may be implemented in software, firmware, hardware or any combination thereof.

The method may comprise, at 72, determining output current data relating to an output current from the voltage regulator to the load. The output current data may be based on a measured current from the voltage regulator to the load. For example, the measured current from the voltage regulator to the load may be a current measured by current monitoring circuitry such as current monitoring circuitry of, or integrated with, the voltage regulator or by current monitoring circuitry of, or integrated with, the load. It may be that the output current data relating to the output current from the voltage regulator to the load is determined by receiving a measured output current of the voltage regulator to the load from the current monitoring circuitry.

The method may comprise, at 74, determining that the voltage regulator is to change from the first power state to the second power state based on a comparison of the determined output current data and power state current threshold data. For example, it may be determined that the voltage regulator is to change from the first power state to the second power state depending on a determination that the output current data indicates an output current greater than or equal to or less than a power state current threshold indicated by the power state current threshold data.

It may be that the method comprises determining regulated voltage data relating to a regulated voltage to be provided by the voltage regulator to the load. It may be that the method comprises determining the power state current threshold data depending on the regulated voltage data (and in some examples depending on predetermined reference data relating the power state current threshold data on the regulated voltage data).

The method may comprise, at 76, sending a power state update command to the voltage regulator to cause a change in the power state of the voltage regulator from the first power state to the second power state based on the said determination that the power state of the voltage regulator is to change from the first power state to the second power state.

Improved power efficiency can be obtained by determining the output current data relating to the output current to be provided by the voltage regulator to the load based on a measured output current from the voltage regulator to the load and determining when to cause a change in the power state of the voltage regulator based on a comparison of the said output current data and power state current threshold data. This is the case even when the regulated voltage data relating to the regulated voltage to be provided from the voltage regulator to the load is not taken into account in the determination of the power state current threshold data. However, it will be understood that greater improvements in power efficiency can be obtained by determining the output current data relating to the output current to be provided by the voltage regulator to the load based on a measured output current from the voltage regulator to the load and determining when to cause a change in the power state of the voltage regulator based on a comparison of the said output current data and power state current threshold data, wherein the power state current threshold data is determined depending on regulated voltage data relating to a regulated voltage to be provided from the voltage regulator to the load.

The present disclosure extends to apparatus comprising means to perform any of the methods disclosed in or derivable from the present disclosure.

The present disclosure extends to machine-readable instructions provided on at least one tangible or non-tangible machine-readable medium, the machine-readable instructions, when executed (e.g. by processing circuitry), to cause processing circuitry to perform any of the methods disclosed in or derivable from the present disclosure. For example, FIG. 15 illustrates such a machine-readable medium 80.

The present disclosure extends to a computer program product comprising instructions which, when the program is executed by a computer, cause the computer to carry out any of the methods disclosed in or derivable from the present disclosure.

The present disclosure extends to means to control a power state of a voltage regulator for providing a regulated voltage to a load by any of the methods disclosed in or derivable from the present disclosure.

The present disclosure extends to means to determine a dependency of a power state current threshold of a voltage regulator on a regulated voltage to be provided by the voltage regulator to a load by any of the methods disclosed in or derivable from the present disclosure.

The present disclosure extends to means for a processor chip to control a power state of a voltage regulator for providing a regulated voltage to a load by any of the methods disclosed in or derivable from the present disclosure.

In this specification, the phrase “at least one of A or B” and the phrase “at least one of A and B” and should be interpreted to mean any one or more of the plurality of listed items A, B etc., taken jointly and severally in any and all permutations.

Where functional units have been described as circuitry, the circuitry may be general purpose processor circuitry configured by program code to perform specified processing functions. The circuitry may also be configured by modification to the processing hardware. Configuration of the circuitry to perform a specified function may be entirely in hardware, entirely in software or using a combination of hardware modification and software execution. Program instructions may be used to configure logic gates of general purpose or special-purpose processor circuitry to perform a processing function.

Circuitry may be implemented, for example, as a hardware circuit comprising processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate arrays (FPGAs), logic gates, registers, semiconductor devices, chips, microchips, chip sets, and the like.

The processors may comprise a general purpose processor, a network processor that processes data communicated over a computer network, or other types of processor including a reduced instruction set computer RISC or a complex instruction set computer CISC. The processor may have a single or multiple core design. Multiple core processors may integrate different processor core types on the same integrated circuit die

Machine readable program instructions may be provided on a transitory medium such as a transmission medium or on a non-transitory medium such as a storage medium. Such machine readable instructions (computer program code) may be implemented in a high level procedural or object oriented programming language. However, the program(s) may be implemented in assembly or machine language, if desired. In any case, the language may be a compiled or interpreted language, and combined with hardware implementations.

Embodiments of the present disclosure are applicable for use with all types of semiconductor integrated circuit (“IC”) chips. Examples of these IC chips include but are not limited to processors, controllers, chipset components, programmable logic arrays (PLAs), memory chips, network chips, and the like. In some embodiments, one or more of the components described herein may be embodied as a System On Chip (SOC) device. A SOC may include, for example, one or more Central Processing Unit (CPU) cores, one or more Graphics Processing Unit (GPU) cores, an Input/Output interface and a memory controller. In some embodiments a SOC and its components may be provided on one or more integrated circuit die, for example, packaged into a single semiconductor device.

### Examples

The following examples pertain to further embodiments.

1. Power management circuitry to control a power state of a voltage regulator for providing a regulated voltage to a load, the voltage regulator being operable in at least first and second different power states, the power management circuitry comprising circuitry to:
determine output current data relating to an output current to be provided by the voltage regulator to the load;
determine regulated voltage data relating to a regulated voltage to be provided by the voltage regulator to the load;
determine power state current threshold data relating to an output current level at which the voltage regulator is to change between the first and second power states, the power state current threshold data depending on the determined regulated voltage data; and
cause a change in the power state of the voltage regulator from the first power state to the second power state based on a comparison of the determined output current data and the determined power state current threshold data.

2. Machine-readable instructions provided on at least one tangible or non-tangible machine-readable medium, the machine-readable instructions, when executed (e.g. by processing circuitry), to cause processing circuitry to:
determine output current data relating to an output current to be provided by a voltage regulator to a load, the voltage regulator being operable in at least first and second different power states;
determine regulated voltage data relating to a regulated voltage to be provided by the voltage regulator to the load;
determine power state current threshold data relating to an output current level at which the voltage regulator is to change between the first and second power states, the power state current threshold data depending on the determined regulated voltage data; and
cause a change in the power state of the voltage regulator from the first power state to the second power state based on a comparison of the determined output current data and the determined power state current threshold data.

3. A method of controlling a power state of a voltage regulator for providing a regulated voltage to a load, the voltage regulator being operable in at least first and second different power states, the method comprising:
determining output current data relating to an output current to be provided by the voltage regulator to the load;
determining regulated voltage data relating to a regulated voltage to be provided by the voltage regulator to the load;
determining power state current threshold data relating to an output current level at which the voltage regulator is to change between the first and second power states, the power state current threshold data depending on the determined regulated voltage data; and
causing a change in the power state of the voltage regulator from the first power state to the second power state based on a comparison of the determined output current data and the determined power state current threshold data.

4. Apparatus comprising means to perform the method of example 3.

5. Means to control a power state of a voltage regulator for providing a regulated voltage to a load, the voltage regulator being operable in at least first and second different power states, the means arranged to:
determine output current data relating to an output current to be provided by the voltage regulator to the load;
determine regulated voltage data relating to a regulated voltage to be provided by the voltage regulator to the load;
determine power state current threshold data relating to an output current level at which the voltage regulator is to change between the first and second power states, the power state current threshold data depending on the determined regulated voltage data; and
cause a change in the power state of the voltage regulator from the first power state to the second power state based on a comparison of the determined output current data and the determined power state current threshold data.

6. Power management circuitry, machine-readable instructions, method, apparatus or means of any one preceding example, wherein the power state current threshold data is dynamically variable depending on the determined regulated voltage data.

7. Power management circuitry, machine-readable instructions, method, apparatus or means of any one preceding example, wherein the power state current threshold data relates to an output current level at which the second power state becomes more power efficient than the first power state.

8. Power management circuitry, machine-readable instructions, method, apparatus or means of any one preceding example, wherein the circuitry or means is to determine, or the machine-readable instructions are to cause the processing circuitry to determine, or the method comprises determining, the power state current threshold data depending on predetermined reference data relating to a dependency of the power state current threshold data on the determined regulated voltage data.

9. Power management circuitry, machine-readable instructions, method, apparatus or means of example 8 wherein the circuitry or means is to retrieve, or the machine-readable instructions are to cause the processing circuitry to retrieve, or the method comprises retrieving, the reference data from the memory to determine the power state current threshold data depending thereon.

10. Power management circuitry, means or apparatus according to example 8 or example 9 further comprising a memory storing the reference data.

11. Power management circuitry, machine-readable instructions, method, apparatus or means according to any one of examples 8 to 10 wherein the reference data comprises value(s) of one or more parameters of a predetermined function for determining the power state current threshold data depending on the determined regulated voltage data.

12. Power management circuitry, machine-readable instructions, method, apparatus or means according to example 11 wherein the circuitry or means is to determine, or the machine-readable instructions are to cause the processing circuitry to determine, or the method comprises determining, the power state current threshold data based on the said function, the said value(s) of the said one or more parameters of the said function and the determined regulated voltage data.

13. Power management circuitry, machine-readable instructions, method, apparatus or means according to example 12 wherein the function is any one or more of: a linear function; a polynomial function; a non-linear function.

14. Power management circuitry, machine-readable instructions, method, apparatus or means according to any of examples 11 to 13, wherein the circuitry or means is to retrieve, the machine-readable instructions are to cause the processing circuitry to retrieve, or the method comprises retrieving, value(s) of the said one or more parameters of the said function from one or more registers to determine the power state current threshold data depending thereon.

15. Power management circuitry, means or apparatus according to example 14 comprising the said one or more registers storing the said value(s) of the said one or more parameters of the said function.

16. Power management circuitry, machine-readable instructions, method, apparatus or means according to any one of examples 11 to 15 wherein the function is a linear function relating to a variation in the power state current threshold data as a function of the determined regulated voltage data, wherein the said one or more parameters of the said function comprises a gradient parameter for the said linear function.

17. Power management circuitry, machine-readable instructions, method, apparatus or means according to example 16 wherein the said one or more parameters further comprises a y axis intercept parameter for the linear function.

18. Power management circuitry, machine-readable instructions, method, apparatus or means according to any one of examples 8 to 17 wherein the reference data comprises reference data specific to the power state current threshold data relating to the output current level at which the voltage regulator is to change between the first and second power states, for example among power state current threshold data relating to output current levels at which the voltage regulator is to change between different pairs of power states.

19. Power management circuitry, machine-readable instructions, method, apparatus or means according to any one of examples 8 to 18 wherein the reference data is first reference data specific to the power state current threshold data relating to the output current level at which the voltage regulator is to change between the first and second power states, the regulated voltage data is first regulated voltage data relating to a first regulated voltage to be provided by the voltage regulator to the load and the power state current threshold data is first power state current threshold data, and wherein the circuitry or means is to determine, or the machine-readable instructions are to cause the processing circuitry to determine, or the method comprises determining, second power state current threshold data relating to a second output current level at which the voltage regulator is to change between the second power state and a third power state, the second power state current threshold data depending on second determined regulated voltage data relating to a second regulated voltage to be provided by the voltage regulator to the load and on second reference data relating to a dependency of the second power state current threshold data on the second determined regulated voltage data, the second reference data being specific to the second power state current threshold data relating to the second output current level at which the voltage regulator is to change between the second and third power states.

20. Power management circuitry, machine-readable instructions, method, apparatus or means according to example 19 wherein the first reference data is different from the second reference data.

21. Power management circuitry, machine-readable instructions, method, apparatus or means according to any one of examples 8 to 20 wherein the reference data is specific to a voltage regulator type of the voltage regulator.

22. Power management circuitry, machine-readable instructions, method, apparatus or means according to any one preceding example, wherein the circuitry or means is to determine, or the machine-readable instructions are to cause the processing circuitry to determine, or the method comprises determining, the output current data based on a predicted output current to be provided by the voltage regulator to the load.

23. Power management circuitry, machine-readable instructions, method, apparatus or means according to example 22 wherein the predicted output current is based on any one or more of: an operating point of the load; a voltage operating point of the load; a temperature of the load; a predetermined application ratio of the load.

24. Power management circuitry, machine-readable instructions, method, apparatus or means according to any one preceding example wherein the circuitry or means is to determine, or the machine-readable instructions are to cause the processing circuitry to determine, or the method comprises determining, the output current data based on a measured current from the voltage regulator to the load.

25. Power management circuitry, machine-readable instructions, method, apparatus or means according to example 24 wherein the determined output current data comprises the measured current from the voltage regulator to the load.

26. Power management circuitry, machine-readable instructions, method, apparatus or means according to example 24 or example 25 wherein the measured current from the voltage regulator to the load is a current measured by current monitoring circuitry of, or integrated with, the voltage regulator or by current monitoring circuitry of, or integrated with, the load.

27. Power management circuitry, machine-readable instructions, method, apparatus or means according to example 26 wherein the circuitry or means is to determine, or the machine-readable instructions are to cause the processing circuitry to determine, or the method comprises determining, the output current data by receiving from the current monitoring circuitry a measured current from the voltage regulator to the load.

28. Power management circuitry, machine-readable instructions, method, apparatus or means according to any one preceding example wherein the circuitry or means is to determine, or the machine-readable instructions are to cause the processing circuitry to determine, or the method comprises determining, the regulated voltage data based on a voltage demanded or a voltage to be demanded for the load from the voltage regulator.

29. Power management circuitry, machine-readable instructions, method, apparatus or means according to example 28 wherein the voltage is demanded or to be demanded for the load from the voltage regulator by way of a voltage identification, VID, code.

30. Power management circuitry, machine-readable instructions, method, apparatus or means according to example 28 or example 29 wherein the voltage is demanded or to be demanded for the load from the voltage regulator by way of a power management communication interface.

31. Power management circuitry, machine-readable instructions, method, apparatus or means according to any one preceding example wherein the circuitry or means is to determine, or the machine-readable instructions are to cause the processing circuitry to determine, or the method comprises determining, the regulated voltage data based on a measurement of a regulated voltage supplied by the voltage regulator to the load.

32. Power management circuitry, machine-readable instructions, method, apparatus or means according to any one preceding example wherein the circuitry or means is to determine, or the machine-readable instructions are to cause the processing circuitry to determine, or the method comprises determining, the power state current threshold data by updating previously determined power state current threshold data relating to an output current level at which the voltage regulator is to change between the first and second power states depending on the determined regulated voltage data.

33. Power management circuitry, machine-readable instructions, method, apparatus or means according to example 32 wherein the power state current threshold data is different from the previously determined power state current threshold data by virtue of the determined regulated voltage data being different from determined regulated voltage data on which the previously determined power state current threshold data depended.

34. Power management circuitry, machine-readable instructions, method, apparatus or means according to any one preceding example, wherein the first and second power states of the voltage regulator differ from each other by way of any one or more of the following: the voltage regulator operates with different phase counts in the first and second power states; the voltage regulator operates in a continuous conduction mode in one of the first and second power states and the voltage regulator operates in a discontinuous conduction mode in the other of the first and second power states; the voltage regulator operates in a discontinuous conduction mode having a first voltage regulator switching frequency in one of the first and second power states and the voltage regulator operates in a discontinuous conduction mode having a second voltage regulator switching frequency different from the first voltage regulator switching frequency in the other of the first and second power states; one or more circuits of the voltage regulator are inactive or powered off in one of the first and second power states and one or more of the said one or more circuits of the voltage regulator are active or powered on in the other of the first and second power states; one or more circuits of the voltage regulator are in a lower power state in one of the first and second power states and one or more of the said one or more circuits of the voltage regulator are in a higher power state in the other of the first and second power states.

35. Power management circuitry, machine-readable instructions, method, apparatus or means according to any one preceding example wherein the voltage regulator is a multi-phase voltage regulator capable of providing an output current and regulated voltage to the load based on one phase in the first power state and based on a plurality of phases in the second power state.

36. Power management circuitry, machine-readable instructions, method, apparatus or means according to any one preceding example wherein the circuitry or means is to cause, or the machine-readable instructions are to cause the processing circuitry to cause, or the method comprises causing, a change in the power state of the voltage regulator from the first power state to the second power state by causing a power state update command to be sent to the voltage regulator.

37. Power management circuitry, machine-readable instructions, method, apparatus or means according to any one of examples 1 to 36 wherein the circuitry or means is to cause, or the machine-readable instructions are to cause the processing circuitry to cause, or the method comprises causing, a change in the power state of the voltage regulator from the power state to the second power state by (e.g. directly) reconfiguring the voltage regulator, such as by changing a phase count of the voltage regulator.

38. Power management circuitry, machine-readable instructions, method, apparatus or means according to any one preceding example wherein the load comprises any one or more of: a computing platform; one or more components of a computing platform; one or more processors; one or more processor chips; circuitry of a processor or processor chip; processing or computing circuitry of a processor or processor chip; one or more domains of a processor chip, such as a domain comprising one or more cores of a multi-core processor; processing circuitry of a central processing unit of a processor chip, such as one or more central processing unit cores; graphics processing circuitry of a processor chip, such as one or more graphics processor cores; at least a first domain of multi-core processing circuitry further comprising a second domain including at least graphics processing circuitry, the first domain including one or more processing cores, such as one or more processing cores of a central processing unit processor; a memory controller; a display controller; non-core circuitry of a processor or processor chip.

39. Power management circuitry, machine-readable instructions, method, apparatus or means according to any one preceding example wherein the power management circuitry or means is to control, or the machine-readable instructions are to cause the processing circuitry to control, or the method comprises controlling, power states of a plurality of voltage regulators for providing respective regulated voltages to respective loads, the voltage regulators each being operable in at least respective first and second different power states, the power management circuitry comprising circuitry to, or the means being arranged to, or the machine-readable instructions to cause the processing circuitry to, or the method comprising, for each of the voltage regulators:
determine (or determining) respective output current data relating to a respective output current to be provided by the respective voltage regulator to the respective load;
determine (or determining) respective regulated voltage data relating to a respective regulated voltage to be provided by the respective voltage regulator to the respective load;
determine (or determining) respective power state current threshold data relating to a respective output current level at which the respective voltage regulator is to change between the respective first and second power states, the respective power state current threshold data depending on the respective determined regulated voltage data; and
cause (or causing) a change in the power state of the respective voltage regulator from the respective first power state to the respective second power state based on a comparison of the respective determined output current data and the respective determined power state current threshold data.

40. Power management circuitry, machine-readable instructions, method, apparatus or means according to any one preceding example, wherein a maximum output current capacity of the voltage regulator is different in the first power state from a maximum output current capacity of the voltage regulator in the second power state.

41. Power management circuitry according to any one preceding example wherein the power management circuitry is power management circuitry for a processor or a processor chip such as a dedicated central processing unit chip or a system on chip.

42. Power management circuitry according to any one of examples 1 to 41 wherein the power management circuitry is power management circuitry for a voltage regulator.

43. A processor or processor chip (e.g. such as a dedicated central processing unit chip or a system on chip) comprising the power management circuitry according to any one of examples 1 to 41.

44. A voltage regulator comprising the power management circuitry according to any one of examples 1 to 40 or example 42.

45. Apparatus comprising:
a load; and
the power management circuitry according to any one of examples 1 to 42, the power management circuitry to control a power state of a voltage regulator for providing a regulated voltage to the load, the voltage regulator being operable in at least first and second different power states.

46. The apparatus of example 45 further comprising the said voltage regulator.

47. A computing platform comprising:
multicore processing circuitry comprising:
   a first domain including one or more cores;
   a second domain including at least graphics processing circuitry;
a voltage regulator to provide a regulated voltage to at least the first domain, wherein the voltage regulator comprises configuration circuitry to dynamically reconfigure the voltage regulator from a first power state to a second power state; and
power management circuitry to:
   determine output current data relating to an output current to be provided by the voltage regulator to the said at least first domain;
   determine regulated voltage data relating to a regulated voltage to be provided by the voltage regulator to the said at least first domain;
   determine power state current threshold data relating to an output current level at which the voltage regulator is to dynamically reconfigure from the first power state to the second power state, the power state current threshold data depending on the determined regulated voltage data; and
   cause the voltage regulator configuration circuitry to dynamically reconfigure the voltage regulator from the first power state to the second power state based on a comparison of the determined output current data and the determined power state current threshold data.

48. The computing platform of example 47 wherein the first and second domains of the multicore processing circuitry are provided by a system-on-chip, SoC.

49. Machine-readable instructions provided on at least one tangible or non-tangible machine-readable medium, the machine-readable instructions, when executed (e.g. by processing circuitry), to cause processing circuitry to:
determine a power efficiency of the voltage regulator for each of a plurality of power states thereof as a function of an output current to be provided by the voltage regulator to a load and as a function of a regulated voltage to be provided by the voltage regulator to the load;
for each of a plurality of regulated voltages to be provided by the voltage regulator to the load, determine a power state current threshold relating to a level of an output current of the voltage regulator to the load at which a first power state of the voltage regulator becomes more power efficient than a second power state of the voltage regulator; and
determine reference data relating to a dependency of the power state current threshold on the regulated voltage to be provided by the voltage regulator to the load.

50. Data processing circuitry comprising one or more processors, the data processing circuitry to:
determine a power efficiency of the voltage regulator for each of a plurality of power states thereof as a function of an output current to be provided by the voltage regulator to the load and as a function of a regulated voltage to be provided by the voltage regulator to the load;
for each of a plurality of regulated voltages to be provided by the voltage regulator to the load, determine a power state current threshold relating to a level of an output current of the voltage regulator to the load at which a first power state of the voltage regulator becomes more power efficient than a second power state of the voltage regulator; and
determine reference data relating to a dependency of the power state current threshold on the regulated voltage to be provided by the voltage regulator to the load.

51. A method of determining a dependency of a power state current threshold of a voltage regulator on a regulated voltage to be provided by the voltage regulator to a load, the voltage regulator being operable in a plurality of different power states, the method comprising:
determining a power efficiency of the voltage regulator for each of a plurality of power states thereof as a function of an output current to be provided by the voltage regulator to the load and as a function of a regulated voltage to be provided by the voltage regulator to the load;
for each of a plurality of regulated voltages to be provided by the voltage regulator to the load, determining a power state current threshold relating to a level of an output current of the voltage regulator to the load at which a first power state of the voltage regulator becomes more power efficient than a second power state of the voltage regulator; and
determining reference data relating to a dependency of the power state current threshold on the regulated voltage to be provided by the voltage regulator to the load.

52. Apparatus comprising means to perform the method of example 51.

53. Means to determine a dependency of a power state current threshold of a voltage regulator on a regulated voltage to be provided by the voltage regulator to a load, the voltage regulator being operable in a plurality of different power states, the means arranged to:
determine a power efficiency of the voltage regulator for each of a plurality of power states thereof as a function of an output current to be provided by the voltage regulator to the load and as a function of a regulated voltage to be provided by the voltage regulator to the load;
for each of a plurality of regulated voltages to be provided by the voltage regulator to the load, determine a power state current threshold relating to a level of an output current of the voltage regulator to the load at which a first power state of the voltage regulator becomes more power efficient than a second power state of the voltage regulator; and
determine reference data relating to a dependency of the power state current threshold on the regulated voltage to be provided by the voltage regulator to the load.

54. Machine-readable instructions, data processing circuitry, method, apparatus or means according to any one of examples 49 to 53 wherein the circuitry or means is to store, or the machine-readable instructions are to cause the processing circuitry to store, or the method comprises storing, the said reference data in memory.

55. Machine-readable instructions, data processing circuitry, method, apparatus or means according to any one of examples 49 to 54 wherein the reference data comprises value(s) of one or more parameters of a function for determining power state current threshold data relating to the output current level at which the first power state becomes more efficient than the second power state depending on regulated voltage data relating to a regulated voltage to be provided by the voltage regulator to the load.

56. Machine-readable instructions, data processing circuitry, method, apparatus or means according to example 55 wherein the circuitry or means is to store, or the machine-readable instructions are to cause the processing circuitry to store, or the method comprises storing, value(s) of the said one or more parameters of the said function in one or more registers, such as in one or more registers of power management circuitry.

57. Power management circuitry for a processor chip to control a power state of a voltage regulator operable in at least first and second different power states, the power management circuitry comprising circuitry to:
determine output current data relating to an output current from the voltage regulator to a load;
determine that the power state of the voltage regulator is to change from the first power state to the second power state based on a comparison of the determined output current data and power state current threshold data; and
send a power state update command to the voltage regulator to cause a change in the power state of the voltage regulator from the first power state to the second power state based on the said determination that the power state of the voltage regulator is to change from the first power state to the second power state,
wherein the determined output current data is based on a measured current from the voltage regulator to the load.

58. Machine-readable instructions provided on at least one tangible or non-tangible machine-readable medium, the machine-readable instructions, when executed (e.g. by power management circuitry of a processor chip), to cause power management circuitry of a processor chip to:
determine output current data relating to an output current from a voltage regulator to a load, the voltage regulator being operable in at least first and second different power states;
determine that the voltage regulator is to change from the first power state to the second state based on a comparison of the determined output current data and power state current threshold data, and
send a power state update command to the voltage regulator to cause a change in the power state of the voltage regulator from the first power state to the second power state based on the said determination that the power state of the voltage regulator is to change from the first power state to the second power state,
wherein the determined output current data is based on a measured current from the voltage regulator to the load.

59. Means for a processor chip to control a power state of a voltage regulator for providing a regulated voltage to a load, the voltage regulator being operable in at least first and second different power states, the means being arranged to:
determine output current data relating to an output current from a voltage regulator to the load;
determine that the voltage regulator is to change from the first power state to the second state based on a comparison of the determined output current data and power state current threshold data, and
send a power state update command to the voltage regulator to cause a change in the power state of the voltage regulator from the first power state to the second power state based on the said determination that the power state of the voltage regulator is to change from the first power state to the second power state,
wherein the determined output current data is based on a measured current from the voltage regulator to the load.

60. A method of controlling a power state of a voltage regulator for providing a regulated voltage to a load, the voltage regulator being operable in at least first and second different power states, the method comprising:
power management circuitry of a processor chip determining output current data relating to an output current from the voltage regulator to the load;
the power management circuitry of the processor chip determining that the voltage regulator is to change from the first power state to the second power state based on a comparison of the determined output current data and power state current threshold data; and
the power management circuitry of the processor chip sending a power state update command to the voltage regulator to cause a change from the first power state to the second power state based on the said determination that the power state of the voltage regulator is to change from the first power state to the second power state,
wherein the determined output current data is based on a measured current from the voltage regulator to the load.

61. Apparatus comprising means to perform the method of example 60.

62. Power management circuitry, machine-readable instructions, means, method or apparatus to any of examples 57 to 61 wherein the processor chip is a dedicated central processing unit chip or a system on chip, SoC, comprising one or more processors.

63. Power management circuitry, machine-readable instructions, means, method or apparatus according to any one of examples 57 to 62 wherein the power management circuitry, means or apparatus is power management circuitry, means or apparatus of the processor chip.

64. Power management circuitry, machine-readable instructions, means, method or apparatus according to any one of examples 57 to 63 wherein the load comprises a load of the processor chip.

65. Power management circuitry, machine-readable instructions, means, method or apparatus according to any one of examples 57 to 64 wherein the load comprises any one or more of: a computing platform; one or more components of a computing platform; one or more processors; one or more processor chips; circuitry of a processor or processor chip; processing or computing circuitry of a processor or processor chip; one or more domains of a processor chip, such as a domain comprising one or more cores of a multi-core processor; processing circuitry of a central processing unit of a processor chip, such as one or more central processing unit cores; graphics processing circuitry of a processor chip, such as one or more graphics processor cores; at least a first domain of multi-core processing circuitry further comprising a second domain including at least graphics processing circuitry, the first domain including one or more processing cores, such as one or more processing cores of a central processing unit processor; a memory controller; a display controller; non-core circuitry of a processor or processor chip.

66. Power management circuitry, machine-readable instructions, means, method or apparatus according to any one of examples 57 to 65 wherein the power management circuitry or means is to determine, or the machine-readable instructions are to cause the power management circuitry to determine, or the method comprises determining, the power state current threshold data depending on regulated voltage data relating to a regulated voltage to be provided by the voltage regulator to the load.

67. A processor chip comprising the power management circuitry, means or apparatus of any of examples 57, 59, 61 or 62-66.

Further examples can be realized by combining one or more selected component of any one example described in this disclosure with one or more selected component of any other one or more example described in this disclosure, or alternatively with one or more features of an appended independent claim. Further examples can be realised comprising one or more components of any herein described example(s) taken jointly and severally in any and all permutations.

Two or more physically distinct components in any described example may alternatively be integrated into a single component where possible, provided that the same function is performed by the single component thus formed. Conversely, a single component of any example implementation described in this disclosure may alternatively be implemented as two or more distinct components to achieve the same function, where appropriate.

1-28. (canceled)

29. An apparatus comprising:
a voltage regulator operable in at least first and second different power states; and
power management circuitry to control a power state of the voltage regulator for providing a regulated voltage to a load, the power management circuitry to:
determine output current data relating to an output current to be provided by the voltage regulator to the load;
determine regulated voltage data relating to a regulated voltage to be provided by the voltage regulator to the load;
determine power state current threshold data relating to an output current level at which the voltage regulator is to change between the first and second power states, the power state current threshold data depending on the determined regulated voltage data; and
cause a change in the power state of the voltage regulator from the first power state to the second power state based on a comparison of the determined output current data and the determined power state current threshold data.

30. The apparatus according to claim 29, wherein the power state current threshold data relates to an output current level at which the second power state becomes more power efficient than the first power state.

31. The apparatus according to claim 29, wherein the circuitry is to determine the power state current threshold data depending on predetermined reference data relating to a dependency of the power state current threshold data on the determined regulated voltage data.

32. The apparatus according to claim 31, wherein the power management circuitry further comprises a memory storing the reference data, the circuitry to retrieve the reference data from the memory to determine the power state current threshold data depending thereon.

33. The apparatus according to claim 31, wherein the reference data comprises value(s) of one or more parameters of a predetermined function for determining the power state current threshold data depending on the determined regulated voltage data, the power management circuitry to determine the power state current threshold data based on the said function, the said value(s) of the said one or more parameters of the said function and the determined regulated voltage data.

34. The apparatus according to claim 33 comprising one or more registers to store the value(s) of the said one or more parameters of the said function, the power management circuitry to retrieve the said value(s) of the said one or more parameters of the said function from the said one or more registers to determine the power state current threshold data depending thereon.

35. The apparatus according to claim 29, wherein the power management circuitry is to determine the output current data based on a measured current from the voltage regulator to the load.

36. The apparatus according to claim 35, wherein the measured current from the voltage regulator to the load is a current measured by current monitoring circuitry of, or integrated with, the voltage regulator or by current monitoring circuitry of, or integrated with, the load.

37. The apparatus according to claim 29, wherein the power management circuitry is to determine the regulated voltage data based on a voltage demanded or a voltage to be demanded for the load from the voltage regulator.

38. The apparatus according to claim 29, wherein the power management circuitry is to determine the power state current threshold data by updating a previously determined power state current threshold data depending on the determined regulated voltage data.

39. The apparatus according to claim 38, wherein the power state current threshold data is different from the previously determined power state current threshold data by virtue of the determined regulated voltage data being different from determined regulated voltage data on which the previously determined power state current threshold data depended.

40. The apparatus according to claim 29, wherein the first and second power states of the voltage regulator differ from each other by way of any one or more of the following: the voltage regulator operates with different phase counts in the first and second power states; the voltage regulator operates in a continuous conduction mode in one of the first and second power states and the voltage regulator operates in a discontinuous conduction mode in the other of the first and second power states; the voltage regulator operates in a discontinuous conduction mode having a first voltage regulator switching frequency in one of the first and second power states and the voltage regulator operates in a discontinuous conduction mode having a second voltage regulator switching frequency different from the first voltage regulator switching frequency in the other of the first and second power states; one or more circuits of the voltage regulator are inactive or powered off in one of the first and second power states and one or more of the said one or more circuits of the voltage regulator are active or powered on in the other of the first and second power states; one or more circuits of the voltage regulator are in a lower power state in one of the first and second power states and one or more of the said one or more circuits of the voltage regulator are in a higher power state in the other of the first and second power states.

41. The apparatus according to claim 29, wherein the load comprises any one or more of: a computing platform; one or more components of a computing platform; one or more processors; one or more processor chips; circuitry of a processor or processor chip; processing or computing circuitry of a processor or processor chip; one or more domains of a processor chip, such as a domain comprising one or more cores of a multi-core processor; processing circuitry of a central processing unit of a processor chip, such as one or more central processing unit cores; graphics processing circuitry of a processor chip, such as one or more graphics processor cores; at least a first domain of multi-core processing circuitry further comprising a second domain including at least graphics processing circuitry, the first domain including one or more processing cores, such as one or more processing cores of a central processing unit processor; a memory controller; a display controller; non-core circuitry of a processor or processor chip.

42. The apparatus according to claim 29, wherein the power management circuitry is to control power states of a plurality of voltage regulators for providing respective regulated voltages to respective loads, the voltage regulators each being operable in at least respective first and second different power states, the power management circuitry comprising circuitry to, for each of the voltage regulators:
determine respective output current data relating to a respective output current to be provided by the respective voltage regulator to the respective load;
determine respective regulated voltage data relating to a respective regulated voltage to be provided by the respective voltage regulator to the respective load;
determine respective power state current threshold data relating to a respective output current level at which the respective voltage regulator is to change between the respective first and second power states, the respective power state current threshold data depending on the respective determined regulated voltage data; and
cause a change in the power state of the respective voltage regulator from the respective first power state to the respective second power state based on a comparison of the respective determined output current data and the respective determined power state current threshold data.

43. The apparatus according to claim 29, further comprising the load.

44. Machine-readable instructions provided on at least one tangible machine-readable medium, the machine-readable instructions, when executed, to cause processing circuitry to:
determine output current data relating to an output current to be provided by a voltage regulator to a load, the voltage regulator being operable in at least first and second different power states;
determine regulated voltage data relating to a regulated voltage to be provided by the voltage regulator to the load;
determine power state current threshold data relating to an output current level at which the voltage regulator is to change between the first and second power states, the power state current threshold data depending on the determined regulated voltage data; and
cause a change in the power state of the voltage regulator from the first power state to the second power state based on a comparison of the determined output current data and the determined power state current threshold data.

45. A method of controlling a power state of a voltage regulator for providing a regulated voltage to a load, the voltage regulator being operable in at least first and second different power states, the method comprising:
determining output current data relating to an output current to be provided by the voltage regulator to the load;
determining regulated voltage data relating to a regulated voltage to be provided by the voltage regulator to the load;
determining power state current threshold data relating to an output current level at which the voltage regulator is to change between the first and second power states, the power state current threshold data depending on the determined regulated voltage data; and
causing a change in the power state of the voltage regulator from the first power state to the second power state based on a comparison of the determined output current data and the determined power state current threshold data.

46. The method of claim 45, further comprising determining the power state current threshold data depending on predetermined reference data relating to a dependency of the power state current threshold data on the determined regulated voltage data.

47. Machine-readable instructions provided on at least one tangible machine-readable medium, the machine-readable instructions, when executed, to cause processing circuitry to:
determine a power efficiency of the voltage regulator for each of a plurality of power states thereof as a function of an output current to be provided by the voltage regulator to a load and as a function of a regulated voltage to be provided by the voltage regulator to the load;
for each of a plurality of regulated voltages to be provided by the voltage regulator to the load, determine a power state current threshold relating to a level of an output current of the voltage regulator to the load at which a first power state of the voltage regulator becomes more power efficient than a second power state of the voltage regulator; and
determine reference data relating to a dependency of the power state current threshold on the regulated voltage.

48. The machine-readable instructions according to claim 47, wherein the reference data comprises value(s) of one or more parameters of a function for determining power state current threshold data relating to the output current level at which the first power state becomes more efficient than the second power state depending on regulated voltage data relating to a regulated voltage to be provided by the voltage regulator to the load.
